(19) United States
(12) Patent Application Publication
(10) Pub. No.: US 2026/0040195 A1
(43) Pub. Date: Feb. 5, 2026

(54) METHODS, ARCHITECTURES, APPARATUSES AND SYSTEMS FOR SENSING IN WIRELESS NETWORKS

(71) Applicant: InterDigital Patent Holdings, Inc., Wilmington, DE (US)

(72) Inventors: Remun Koirala, London (GB); Fumihiro Hasegawa, Westmount (CA); Paul Marinier, Brossard (CA); Moon-il Lee, Melville, NY (US); Ghyslain Pelletier, Montreal (CA); Tao Deng, New York, NY (US); Kunjan Shah, London (GB); Frank LaSita, Long Beach, NY (US)

(21) Appl. No.: 18/795,089

(22) Filed: Aug. 5, 2024

(51) Int. Cl. H04W 48/16; H04W 24/10; H04W 48/12

(52) U.S. Cl. CPC H04W 48/16; H04W 24/10; H04W 48/12

(57) ABSTRACT

Procedures, methods, architectures, apparatuses, systems, devices, and computer program products for dynamic sensing configuration of a wireless network node (e.g., a Wireless Transmit/Receive Unit). Dynamic sensing configuration may be sent via a downlink control channel (e.g., DCI). The sensing configuration may specify expected characteristics of a reflection of a reference signal from a target object. A WTRU may be controlled to perform a sequence of dynamically configured sensing measurements in which different sensing configurations are applied to different measurements to manage the allocation of its resource to the sequence of measurements. A sequence of measurements may be triggered in response to the detection of an event (e.g. an object detection event) by the WTRU. The WTRU is thus controlled to perform a sequence of measurements of reflections from the object during a relevant time period thereby efficiently allocating the resources of a wireless network for sensing.

### TECHNICAL FIELD

The present disclosure is generally directed to the fields of communications, software and encoding, including, for example, to methods, architectures, apparatuses, systems related to sensing in wireless networks.

### BACKGROUND

Conventional cellular wireless networks provide a facility for establishing the position of a WTRU connected to the network. Recently, investigations have been carried out into the feasibility of operating a wireless network to establish the position of an object not connected to the network by operating a wireless network node to observe reflections of wireless signals transmitted by the same wireless network node or another wireless network node.

The primary purpose of cellular networks nevertheless remains the provision of communications services. There is a need to ensure that any sensing facility uses network resources efficiently so that the provision of communication services is not adversely affected.

### SUMMARY

In certain representative embodiments, a wireless transmit/receive unit (WTRU) may perform a dynamically configurable sensing measurement method. The WTRU may perform a set of sensing measurements of a reference signal on respective predetermined measurement occasions. The WTRU may receive a first sensing configuration indication and a second sensing configuration indication. On one of the predetermined measurement occasions, the WTRU may perform one of the set of sensing measurements of the reference signal in accordance with the first sensing configuration. On a later one of the predetermined measurement occasions, the WTRU may perform another one of the set of sensing measurements of the reference signal in accordance with the second sensing configuration.

The disclosure provides dynamic sensing configuration of a wireless network node (e.g., a Wireless Transmit/Receive Unit). Dynamic sensing configuration may be sent via a downlink control channel which is also used to configure the WTRU for communication services. The sensing configuration may specify expected characteristics of a reflection of a reference signal from a target object. A WTRU may be controlled to perform a sequence of dynamically configured sensing measurements in which different sensing configurations are applied to different measurements to manage the allocation of its resource to the sequence of measurements. A sequence of measurements may be triggered in response to the detection of an event (e.g. an object detection event) by the WTRU. The WTRU is thus controlled to perform a sequence of measurements of reflections from the object during a relevant time period thereby efficiently allocating the resources of a wireless network for sensing.

In certain representative embodiments, a WTRU may perform the dynamically configurable sensing method in response to receiving an activation command.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates a comparison of a reference path profile with a measured path profile;

FIG. 3 illustrates a procedure in which a wireless network establishes sensing capabilities of a WTRU;

FIG. 4 illustrates associations between configuration and assistance data structures;

FIG. 5 illustrates different types of assistance information used in a first procedure and a second procedure;

FIG. 6 illustrates a relative delay range indication between minimum and maximum;

FIG. 7 illustrates a sensing coverage area determined based on maximum and minimum relative delay range(s) according to one or more embodiments;

FIG. 8 illustrates zone ID(s) configured by a network according to one or more embodiments;

FIG. 9 illustrates absolute and relative frequency indications according to one or more embodiments;

FIG. 10 illustrates an event-driven sensing procedure;

FIG. 11 illustrates a dynamically configurable scheduled sensing procedure;

FIG. 12 illustrates a sensing procedure which senses different reference signal beams on different measurement occasions;

FIG. 13 illustrates association and no association events according to one or more embodiments;

FIG. 14 illustrates exemplary changes in measurement and/or reporting configuration according to one or more embodiments;

FIG. 15 illustrates an example of a sensing procedure which moves from an event-driven sensing procedure to a dynamically configurable sensing procedure;

FIG. 16 illustrates the performance of a sequence of measurements on an activation command; and

FIG. 17 illustrates a dynamically configurable sensing procedure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

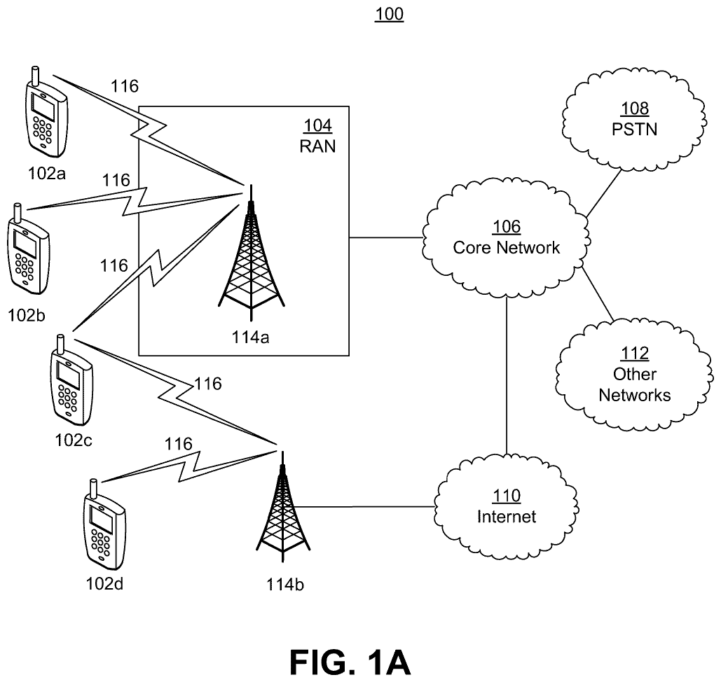

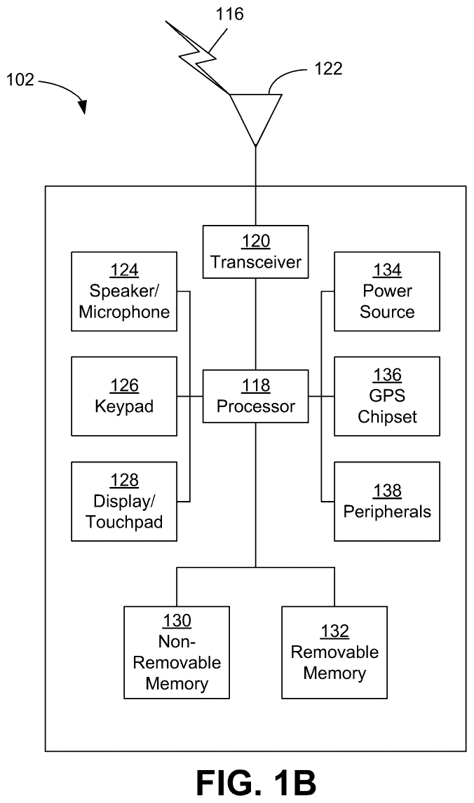

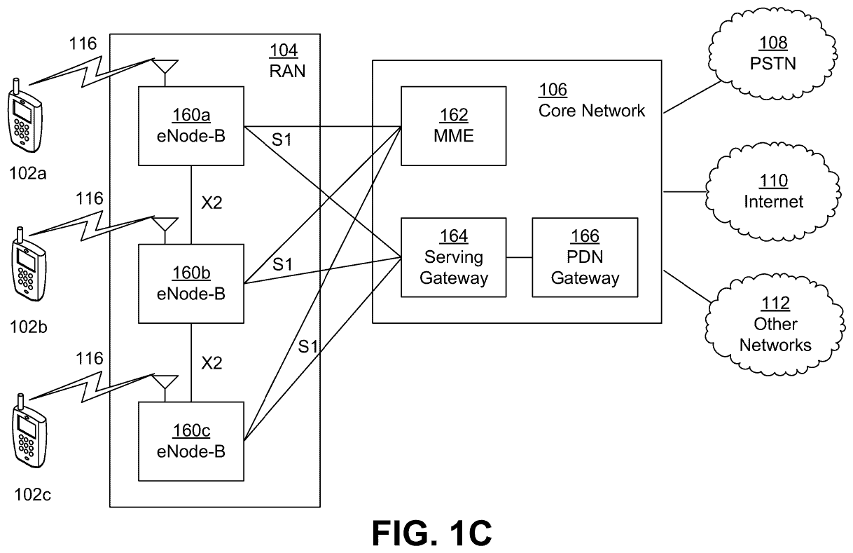

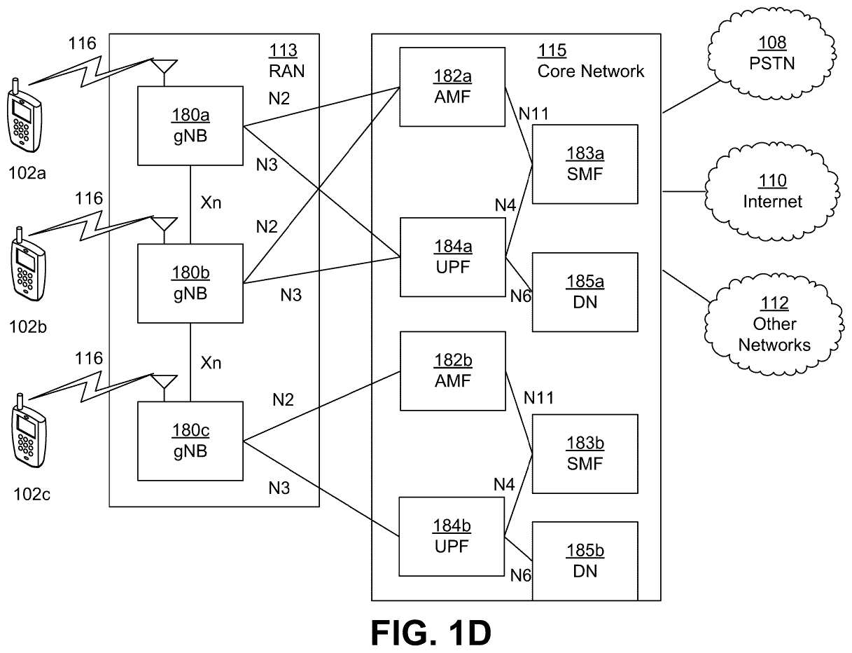

The methods, apparatuses and systems provided herein are well-suited for communications involving both wired and wireless networks. An overview of various types of wireless devices and infrastructure is provided with respect to FIGS. 1A-ID, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-ID as a wireless terminal, it is contemplated that in certain representative embodiments that such a terminal may use (e.g., temporarily or permanently) wired communication interfaces with the communication network. In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHZ, 80 MHZ, and/or 160 MHz wide channels. The 40 MHZ, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-ID, and the corresponding description of FIGS. 1A-ID, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

In certain representative embodiments, procedures for measurement and reporting for tracking in Downlink (DL) bistatic sensing is provided.

In certain representative embodiments, sensing involves detecting, estimating, and monitoring conditions of the environment and/or objects within the environment (e.g., shape, size, orientation, speed, location, distances or relative motion between objects, etc.) using Radio Frequency (RF) signals. In certain representative embodiments, sensing in the context of Integrated Sensing and Communications (ISAC) including the use cases, potential enhancements to the 5G systems, different sensing modes and Key Performance Indicators (KPIs) related to sensing is provided. In certain representative embodiments, different sensing modes including monostatic and bistatic sensing may be defined depending on the transmitter and receiver location. Monostatic sensing mode refers to the architecture with co-located transmitter and receiver and bistatic sensing mode refers to non-co-located transmitter and receiver. Likewise, multi-static sensing refers to the bistatic sensing mode with multiple transmitters and/or receivers.

In certain representative embodiments, tracking for sensing may consist in monitoring of one or more target objects which may be mobile or static over more than one measurement occasions. The tracking may include determining the location, speed, path trajectory, direction, etc. of the target object over time.

In certain representative embodiments, sensing can be performed network based, user equipment (WTRU) assisted, or WTRU based. These may differ in the role of each node in the sensing infrastructure (e.g., Transmission Reception Point (TRP), WTRU, core network (e.g., sensing management function (SMF), location management function (LMF), other higher layer entities (e.g., applications) etc.). The sensing information may be measurement(s), location information of the target object(s), velocity information of the target object(s), etc.

In certain representative embodiments, a WTRU may receive an activation for second configuration(s) from a network with a tracking path ID.

In certain representative embodiments, before measurement occasions, the WTRU may receive (e.g., via Downlink Control Information (DCI)) Downlink Positioning Reference Signal (DL-PRS) resource, measurement and reporting configuration activations.

In certain representative embodiments, the WTRU may receive and perform path measurements, associate the measurement to that of the tracking path ID based on association conditions and report the updated measurements to the network.

In certain representative embodiments, sensing, tracking a (e.g., mobile) target object may be an important use case from the perspective of safety (e.g., unmanned aerial vehicle (UAV), vehicles, etc.). Due to the nature of the use case and the mobility aspect, the WTRU may need to determine the measurements and hence the object location efficiently and accurately to be able to track the object.

In certain representative embodiments, Transmission/Reception Point (TRP) to WTRU bistatic/static sensing is provided where the TRP is the sensing transmitter, and the WTRU is the sensing receiver.

3GPP for New Radio (NR) does not currently have any special functionalities or support dedicated to sensing. However, 3GPP has defined various features for NR positioning including Downlink/Uplink (DL/UL) reference signals, architecture, protocols, etc. Sensing features may be developed based on the NR positioning features.

For multipath measurement, 3GPP has specified reference signal received path power (RSRPP) measurement for (downlink-Positioning Reference Signal) DL-PRS and per path reporting of reference signal time difference (RSTD)/UE Rx-Tx time difference/DL-PRS-RSRPP.

3GPP has also specified static or semi-static (e.g., radio resource control (RRC)) configurations for DL-PRS, measurement and/or reporting configuration. Considering the dynamic nature of tracking use cases (e.g., WTRU mobility, object mobility etc.), these static and/or semi-static configuration(s) may not be optimal.

In certain representative embodiments, for tracking target objects during DL bistatic sensing, the WTRU may efficiently perform measurements and/or reporting.

In certain representative embodiments, the WTRU may terminate a second procedure, for example a tracking procedure, based on an indication from the network.

Throughout this disclosure, “TRP” may be used interchangeably with “gNB” or Positioning Reference Unit “PRU” or “sensing transmitter” or a “WTRU” or a “UE”. The term “TRP” may be used to indicate an entity (e.g., RAN entity) capable of transmitting a reference signal (E.g., DL-PRS, Synchronization Signal Block (SSB), Channel State Information Reference Signal (CSI-RS), etc.).

Throughout this disclosure, “WTRU” may be used interchangeably with “sensing receiver” and may be used to indicate an entity (e.g., RAN entity) capable of receiving and measuring reference signal (E.g., DL-PRS, Synchronization Signal Block (SSB), Channel State Information Reference Signal (CSI-RS), etc.).

Throughout this disclosure, “Network” may refer to the access mobility function (AMF), LMF, gNB, NG RAN, or any other entity involved in sensing functionalities (e.g., SMF)).

Throughout this disclosure, “location” may be used interchangeably with “position”.

Throughout this disclosure, a location (e.g., WTRU location, TRP location, etc.) may be expressed in terms of altitude, latitude, geographic coordinate, or local coordinate, for example.

Throughout this disclosure, a “measurement occasion” may be defined as an instance where the WTRU measures the metrics (e.g., RSRPP, AoA, etc.) from a reference signal. A “reporting occasion” may be defined as an instance where the WTRU reports the measurements.

Throughout this disclosure, a “reference signal (RS)” may refer to any of the positioning and reference signals, for e.g., DL-PRS, Sounding Reference Signal (SRSp), CSI-RS, Demodulation Reference Signal (DM-RS), SSB etc.

Throughout this disclosure, a “DL-PRS” may refer to any of the downlink positioning or any other reference signals that may be received and/or measured by the WTRU, e.g., SSB, CSI-RS etc.

Throughout this disclosure, the WTRU may receive (pre) configured threshold(s) from the network (e.g., LMF, gNB) via downlink physical channel (e.g., Physical Downlink Shared Channel (PDSCH), Physical Downlink Control Channel (PDCCH), etc.) or via lower or higher layer signalling (e.g., Downlink Control Information (DCI), Medium Access Control Control Element (MAC-CE), Radio Resource Control (RRC) or LTE Positioning Protocol (LPP) message).

Throughout this disclosure, an LMF is a non-limiting example of a node or entity (e.g., network node or entity) that may be used for or to support positioning and/or sensing. Any other node or entity (e.g., server WTRU, sensing management function) may be substituted for LMF and still be consistent with this disclosure.

Throughout this disclosure, “ID” may be used interchangeably with “index”.

Throughout this disclosure, the WTRU may receive configurations (e.g., Reference Signals (RS) configurations, measurement configurations, reporting configurations, etc.) from the network (e.g., LMF, gNB) via downlink physical channel (e.g., PDSCH, PDCCH, etc.) or via lower or higher layer signalling (e.g., DCI, MAC-CE, RRC or LTE positioning protocol (LPP) message).

In certain representative embodiments, the WTRU may send the measurement report, containing the measurements, to the network (e.g., LMF, gNB) via a semi-static (e.g., LPP, RRC) or dynamic message (e.g., Uplink Control Information (UCI), MAC-CE).

In certain representative embodiments, the WTRU may indicate RS resource index, and/or RS index or ID, associated with measurements, in the measurement report to indicate which RS(s) the WTRU measured to derive the measurements (e.g., RSRPP, AoA, etc.). The WTRU may include a TRP ID or index in the measurement report to indicate which TRP's DL-PRS(s) the WTRU made measurements on.

Throughout this disclosure, a RSRPP (or RSRP) threshold may be defined with respect to first path RSRPP (or RSRP) (e.g., threshold of 3 dB lower than that of first path). In this case, the threshold may be −3 dB.

Throughout this disclosure, an area may be defined as a region and may be define in terms of at least one of the following: i) Coarse location defined by an ellipsoid point (e.g., defined by latitude degree, longitude degree and/or latitude sign, etc.) or a geographical location (e.g., 2D location, 3D location) and may consist additionally of an uncertainty region (e.g., circle, sphere, ellipse, ellipsoid, etc.); ii) Zone ID defined with reference to a geographical reference (e.g., (0, 0)) and may refer to a geographical area (e.g., square area of zone length L, etc.) defined a point and the length of the square. In one example, for a given zone length L (e.g., configured by the network), the WTRU may be able to determine the area based on the ID based on a mathematical mapping equation or a table; iii) Any other representation of a geographical area (e.g., set of points (e.g., convex hull around a point), a location representing center of a shape (e.g., rectangle) and the associated parameters, etc.)

Throughout this disclosure, a “first procedure” can be interchangeably used with a “first configuration”, “first DL-PRS configuration”, “first measurement configuration”, “first reporting configuration”, “first TRP” etc. and a “second procedure” can be interchangeably used with a “second configuration”, “second DL-PRS configuration”, “second measurement configuration”, “second reporting configuration”, “second TRP” etc.

Throughout this disclosure, dependency of a first parameter with a second parameter may be interpreted as the first parameter may be a first value if the second parameter is above a (pre) configured threshold, and a second value otherwise.

Throughout this disclosure, a “path” may be used interchangeably with “multipath”.

Throughout this disclosure, one or more DL-PRS resource ID(s) and/or beam ID(s) may be associated with one or more TRPs. DL-PRS resource ID(s) and/or DL-PRS beam ID(s) may be associated or interchangeably used with “TRP ID(s)”. Determination or reception of “DL-PRS configuration”, measurement(s) with “DL-PRS resource(s)” or “DL-PRS beam ID(s)” and/or reporting of “DL-PRS resource(s)” may correspond to determination or reception of TRP ID, measurement associated with resources from a TRP and/or reporting a TRP ID.

In certain representative embodiments, a WTRU may receive multiple DL-PRS, measurement and reporting configurations for first and second procedures. The WTRU may receive reporting events for the first procedure including an angle of arrival (AoA) range. Once an event is satisfied, the WTRU may receive an activation command for a second procedure with a window. Within the window, the WTRU may receive a dynamic control information (DCI) to trigger measurement (e.g., which DL-PRS to measure, which AoA range to track) and control reporting behavior. The WTRU may determine to fall back to the first procedure if the termination conditions for the second procedure is satisfied.

In certain representative embodiments, a WTRU may receive configurations for periodic DL-PRS, first measurement and reporting (e.g., event-based) configurations and set(s) of second measurement (e.g., MeasConfig ID(s)) and reporting (e.g., periodic) reporting configurations (e.g., ReportConfig ID(s)) from the network.

The WTRU may receive first and second assistance information (e.g., Assistance ID(s)) including Ref. DL-PRS ID, and first and second set(s) of trigger conditions including [min, max] AoA range and Reference Signal Received Path Power (RSRPP) threshold.

The WTRU may receive DL-PRS resources, perform per path measurements (e.g., AoA, RSRPP) on the Ref. DL-PRS ID and allocate ID(s) to the path(s).

In certain representative embodiments, the WTRU may determine its Rx boresight direction and width based on the first trigger condition (e.g., [min, max] AoA range) for reporting.

The WTRU may measure the DL-PRS resources based on the first measurement configuration.

The WTRU may report the path ID(s) and the associated measurement(s) to the network based on the first trigger condition, i.e., if the measured AoA of a path ID with RSRPP above threshold is within the [min, max] AoA range.

The WTRU may receive an activation command for second configuration(s) with a tracking window (e.g., start time, duration) and a tracking path ID from the network.

The activation command may activate the second set(s) of measurement and reporting (e.g., periodic) configuration(s) and second set(s) of trigger conditions.

For tracking the object the WTRU may—for example in every measurement occasion—receive (e.g., via DCI) an indication of a second assistance information(s) (e.g., Assistance ID) from the network.

The WTRU may determine the DL-PRS resource for measurement based on: i) DL-PRS ID associated with the tracking path ID (e.g., in previous occasion), ii) (e.g., difference of) RSRPP and AoA measurement compared to previous occasion(s), iii) (e.g., DCI) indication from the network, etc.

The WTRU may determine parameter(s) of second measurement (e.g., periodicity, k-factor, etc.) and/or second reporting (e.g., periodicity, granularity, etc.) configuration based on: i) (e.g., difference of) RSRPP and AoA measurement compared to previous occasion(s), ii) WTRU location (e.g., located in a zone), iii) (e.g., DCI) indication from the network (e.g., MeasConfig ID and/or ReportConfig ID) etc.

The WTRU may receive and measure the path(s) with tracking DL-PRS ID(s) based on the determined measurement configuration.

The WTRU may associate the measurement of a path to that of the tracking path ID based on the indicated assistance information, e.g., measured AoA of a path with RSRPP above threshold within the [min, max] AoA range).

The WTRU may report the updated measurements if associated with the tracking path ID and may report an event of no association otherwise.

The WTRU may determine to deactivate the tracking window and terminate second procedure if: the number of (e.g., consecutive) no association events is above a threshold, the tracking window expires, or the WTRU may receive window deactivation command from the network.

The WTRU may determine to perform measurements and reporting based on the first measurement and reporting condition based on the first assistance information.

In certain representative embodiments, a WTRU is provided to dynamically receive and/or determine configuration(s) for the second procedure (e.g., tracking). The WTRU may determine optimal measurement and/or reporting configuration(s) for tracking in order to sense the target object with required QoS requirements (e.g., accuracy, latency, etc.).

### Configuration for DL-PRS

In certain representative embodiments, a DL-PRS configuration may contain at least one of the following parameters: number of symbols, transmission power, number of DL-PRS resources included in DL-PRS resource set, muting pattern for DL-PRS (for example, the muting pattern may be expressed via a bitmap), periodicity, type of DL-PRS (e.g., periodic, semi-persistent, or aperiodic), slot offset for periodic transmission for DL-PRS, vertical shift of DL-PRS pattern in the frequency domain, time gap during repetition, repetition factor, RE (resource element) offset, comb pattern, comb size, spatial relation, Quasi Co-Location (QCL) information (e.g., QCL target, QCL source) for DL-PRS, number of PRUs, number of TRPs, Absolute Radio-Frequency Channel Number (ARFCN), subcarrier spacing, expected RSTD, uncertainty in expected RSTD, start Physical Resource Block (PRB), bandwidth, BWP ID, number of frequency layers, start/end time for DL-PRS transmission, on/off indicator for DL-PRS, TRP ID, DL-PRS ID, cell ID, global cell ID, PRU ID, and applicable time window. The WTRU may apply a DL-PRS configuration under a condition that the current time is within the applicable time window. The WTRU may receive beam width of a DL-PRS or boresight direction (e.g., Azimuth Angle of Departure (AoD)) of DL-PRS from the network. The configuration described herein is not limited to DL-PRS. It can be applicable to any DL RS.

“DL-PRS” and “PRS” and “DL PRS” and “DL-RS” may be used interchangeably herein. “DL-PRS ID(s)” or “DL-PRS resource ID(s)” or “DL-PRS beam ID” or “DL-PRS resource ID(s) may be associated with one or more TRPs.

### Measurement Configuration

In certain representative embodiments, a measurement configuration may include at least one of: measurement object including the measurement time and/or frequency location; subcarrier spacing; “exclude-listed” cell and “allowed listed cell”; measurement identities; measurement filtering configurations; measurement gaps; L3 filtering coefficient (e.g., associated with different measurements); number of measurements per DL-RS beam to be averaged; measurement DL-RS configuration; QCL relationship of the DL-RS beams to be measure, etc.

### Reporting Configuration

In certain representative embodiments, a reporting configuration may include at least one of: reporting configuration ID, reporting type (e.g., periodic, event-triggered). For each of the reporting types, the WTRU may be configured with at least one of the following: RS type (e.g., SSB, CSI-RS, DL-PRS) to provide measurement report on, report interval (e.g., in milliseconds, seconds, minutes, etc.), report amount (e.g., number of measurement reports), cell report quantity (e.g., cell measurement quantities to be included in the report), max report cell (e.g., maximum number of non serving cells included in the measurement report), DL-RS index report quantity (e.g., measurement quantity per DL-RS index to be included in the measurement report), include beam measurement (e.g., whether to include measurements in the report per DL-RS beam), include Common Location Info (e.g., whether to include WTRU location information such as location coordinates, location time stamp, velocity estimate, location error, location source, etc.), coarse location request (e.g., WTRU's coarse location information).

In certain representative embodiments, for the event-triggered reporting type, the WTRU may be configured with at least one or more events, e.g., indicated by event ID. For each event, the WTRU may be configured with at least one of the following: one or more threshold(s) indicated in terms of measurement trigger quantity such as RSRP, RSRPP (e.g., per path, absolute value, relative value with respect to a reference path (e.g., first path)), AoA (e.g., per path, associated with first path, associated with n-th path, etc.), Signal-to-Interference-plus-Noise Ratio (SINR), Doppler shift, etc., and/or an RS type such as SSB, CSI-RS, DL-PRS, etc. or DL RS and/or a DL-RS beam in terms of SSB-ID, CSI-RS beam ID, DL-PRS ID, etc., report on leave (e.g., indicating whether the WTRU may report when leaving or exit condition is met), time to trigger (e.g., indicating the time (e.g., duration) during which criteria for the event should be met to trigger a report), hysteresis, hysteresis altitude, hysteresis location, etc. used in the entry and leave condition of an event triggered reporting.

### Measurement Definitions

RSRPP Measurements: RSRPP (e.g., in terms of dBm, dBW, etc.) may be defined as the path-wise power measurement that may be associated with a path, where, a path may be characterized by, in one example, an i-th measurement component (e.g., i-th delay component, i-th AoA component, etc.) of the resource elements that carry DL RS signal(s). For example, the RSRPP associated with the 1-st path measurements (e.g., 1-st delay component, 1-st AoA component) corresponds to the power contribution associated with the first detected path in time and so on.

AoA Measurements: the AoA (e.g., measured in degrees, radians, etc.) may be defined as the azimuth and/or the vertical angle with which the WTRU receives the transmitted RS with respect to a reference direction. This reference direction may either be defined in the global coordinate system (e.g., geographical north) or in the local coordinate system (e.g., orientation of the WTRU measured in terms of Euler angles (e.g., degrees, radians)). In certain representative embodiments, the WTRU may measure the AoA per path associated with the received DL RS. The WTRU may determine the AoA based on algorithm (e.g., subspace-based algorithms such as MUSIC/ESPIRIT) and/or based on the angles of the receive beam used to receive the RS (e.g., angle associated with the Rx filter) if the WTRU is able to perform Rx beamforming, based on WTRU capability. The resolution of the measured AoA may depend on the number of antenna elements and/or the antenna pattern at the WTRU, the granularity of Rx beams by the WTRU, etc.

Relative delay measurements: In one example, a relative delay (e.g., measured in terms of number of symbols, slots, frames, subframes, seconds, etc.) measurement of a path (e.g., i-th path) may be defined as the time duration associated with the delay component (e.g., i-th delay component) of the resource elements that carry received DL RS with respect to the reference delay component (e.g., 1-st delay component of the DL RS). The granularity of measuring the excess delays may be dependent on the time measurement resolution capability of the WTRU. This capability, in one example, may depend on the signal bandwidth for sensing. Additionally, the resolution may also depend on the ability of the WTRU to process (e.g., compute Fast Fourier Transform (FFT)) large frequency domain samples.

### Path Measurements

In certain representative embodiments, a WTRU may be configured with or may be configured to determine a path profile, consisting of at least one of the following:

i) an identifier (e.g., numeric ID, alpha-numeric ID, path ID #1, path ID #a etc.), the identifier may be for e.g., path ID and/or path index and/or path group index, E.g., first path may be identified as Path #1, second path as Path #2 and so on.

ii) Path ID association criteria, for example, AoA measurement (e.g., with a reference direction) if the path measurements are associated on the basis of AoA, relative delay (e.g., with a reference time) if the path measurements are associated with respect to the relative delay, etc. In one example, the measurement(s) may be a range of measurements (e.g., AoA range, relative delay range, etc.) if the path(s) measurements are associated based on measurements in the same range. For e.g., Path #1 may be associated to AoA measurements within 20 degrees and 30 degrees.

iii) One or more associated path measurements, e.g., one or more RSRPP measurements, one or more AoA (e.g., per path) measurements, one or more delay spread measurements, one or more Doppler shift (e.g., per path) measurements, one or more Doppler spread measurements.

iv) One or more associated RS(s): e.g., Association between different beams of the DL-RS(s), e.g., DL-PRS beam ID #1 and DL-PRS beam ID #2, E.g., Association between DL-PRS and CSI-RS beams, E.g., Association between DL-RS(s) and UL-RS(s), e.g., DL-PRS and SRSp, DL-PRS beam ID #1 and SRSp beam ID #1, etc. E.g., the association may be a quasi-colocation (QCL) association.

In certain representative embodiments, a path profile may consist of one or more path ID(s) with the associated criteria, measurements, and/or RS(s).

In certain representative embodiments, the WTRU may receive a request from the network to determine a path profile, with a reference including at least one of the following: i) a reference DL-PRS resource and/or DL-PRS beam ID, ii) a reference path profile consisting of at least one of the following: one or more reference path ID(s) and for each path ID(s), the associated criteria, reference measurement(s) and/or associated RSs, e.g., DL-RS(s), UL-RS(s).

In certain representative embodiments, the WTRU may determine that a path exists if a measurement associated at a time instance is above a threshold (e.g., RSRP). For example, the WTRU may be configured with a measurement range, e.g., 0 to 2 μs. The WTRU may determine that a path exists at 1 μs (microseconds) if RSRP measured at 1 μs (microsecond) within the range is above a configured RSRP threshold.

In certain representative embodiments, the WTRU may determine the path ID(s) when the reference is configured based on at least one of the following: i) if the WTRU is configured with a reference DL-PRS resource ID or a reference DL-PRS beam ID, the WTRU may determine to use the multipath measurement(s) associated with the reference DL-PRS resource and/or beam ID as the reference measurements for path ID determination, ii) if the WTRU is configured with a reference path profile, the WTRU may determine to use the measurement of the criteria associated with the reference path profile as the reference measurements for path ID determination, e.g., if the criteria is AoA per path, the WTRU may determine to use the AoA associated with each path ID as the reference measurement.

The WTRU may determine to use the same reference for the measurements as the one associated with the reference measurements to determine the path profile, e.g., if the reference for the reference AoA measurement is true north, the WTRU may determine to change the reference of the measurements to true north if that is not the case, or determine to invalidate or not use the measurements for determination of the path profile, e.g., if the reference for reference excess delay measurements is the direct path between the TRP and the WTRU, the WTRU may determine to use the same reference during path ID determination, determine not to use the measurement(s) for determination of path ID(s) etc.

In certain representative embodiments, the WTRU may determine path ID(s) of based on at least one of the following: i) the multipath measurements (e.g., RSRPP and/or Doppler shift, etc.) is above a (pre) configured threshold, ii) the difference between the reference measurement(s) (e.g., reference RSRPP, reference Doppler shift, reference relative delay(s) and/or the reference AoA(s)) and the path measurements (e.g., RSRPP, Doppler shift, relative delay, and/or AoA) is below a (pre) configured threshold, etc.

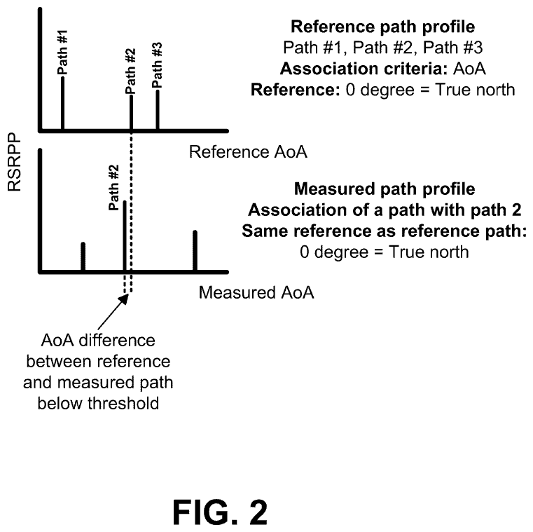

FIG. 2 illustrates a path determination based on a reference path profile according to one or more embodiments. A WTRU may be configured with a reference path profile with path #1, path #2 and path #3 and associated AoA and RSRPP measurement(s) with the association criteria as AoA. The AoA reference for the indicated path profile may be true north. In certain representative embodiments, the reference may be the measurement associated with the previous measurement occasion. The WTRU may determine an association of path #2 with the reference profile based on the AoA difference of the path with that of path #2 of the reference measurement being below a (pre) configured threshold.

In certain representative embodiments, the WTRU may determine the same path ID(s) of the measurements as the associated reference path ID (e.g., in case of association). The WTRU may update the measurement(s) for the path ID based on the measurements, e.g., new measurement, averaged measurement, filtered measurement (e.g., Layer-3 filtering) etc.

In certain representative embodiments, the indicated reference path profile and/or reference DL-PRS resource and/or beam ID(s) may correspond to the measurements and/or reporting in the previous measurement and/or reporting occasion(s). The WTRU may be configured to use the previous measurement occasion reference(s) including least one of the following: i) explicit indication, e.g., reference path profile indication, reference DL-PRS resource(s) and/or DL-PRS ID(s), etc., indication of the time instance associated with the measurement and/or reporting of previous occasion(s), ii) indication of measurement configuration ID(s) and/or reporting configuration ID(s) associated with the measurement and/or reporting in the previous occasion(s), iii) indication of report ID associated with previous reporting occasion(s), iv) indication of path ID(s) (e.g., Path ID #4).

In certain representative embodiments, the WTRU may be configured to determine the path profile based on the measurement(s) without a reference.

In certain representative embodiments, the WTRU may determine the reference DL-PRS resource(s) and/or beam ID(s), reference multipath profile, etc. (e.g., for path determination) if the: i) measurement(s) (e.g., RSRPP (e.g., average, maximum, etc.), RSRP, delay spread, Doppler spread, Doppler shift) associated with a DL-PRS resource(s) ID(s) and/or DL-PRS beam ID(s) is above a (pre) configured threshold, or ii) the difference in measurement(s) (e.g., RSRPP, RSRP, delay spread, Doppler spread, Doppler shift, etc.) associated with a DL-PRS resource(s) ID(s) and/or DL-PRS beam ID(s) (e.g., between measurement occasion(s)) is below a (pre) configured threshold, or iii) the DL-PRS resource(s) or DL-PRS beam ID(s) with its boresight direction (e.g., azimuth angle of departure (AoD), zenith angle of departure (ZoD), etc.) being directed to a (pre) configured reference direction (e.g., towards the UE location, reference location, etc.) or a reference area (e.g., coarse location, zone ID), etc.

The WTRU may determine the path ID(s) with the measurement(s) from one or more DL-PRS resource(s) based on the reference measurements associated with the reference DL-PRS ID(s).

In certain representative embodiments, the WTRU may determine the path ID(s) to the path measurement(s) based on at least one of the following conditions:
i) The measurement(s) (e.g., RSRPP, Doppler shift, etc.) being above a (pre) configured threshold,
ii) The measurement(s) (e.g., relative delay with respect to a reference time, AoA) being within a configured certain range (e.g., between a minimum and a maximum),
iii) The measurement(s) being associated with the reference DL-PRS resource and/or beam etc.

In certain representative embodiments, the WTRU may be configured to report at least one of the following to the network: determined path ID(s) (e.g., path #4), association criteria (e.g., AoA, relative delay measurements), measured DL-PRS resource ID(s), DL-PRS beam ID(s), DL-PRS resource set ID(s), TRP ID(s), measurement(s), uncertainties associated with the measurement(s), timestamp associated with the measurements (e.g., in terms of symbol index, slot index, frame index, sub-frame index, absolute time, relative time with respect to a reference time, etc.), reference path measurement (e.g., occasion time index if associated with previous measurement and/or reporting occasion(s), etc.), reference DL-PRS resource ID, DL-PRS beam ID, etc.

In certain representative embodiments, a WTRU may receive DL-PRS configuration (e.g., time, frequency), AoA_difference threshold and RSRPP threshold from the network for path ID determination.

The WTRU may receive a reference path profile with at least one of reference DL-PRS ID(s), reference path ID(s) (e.g., path #1, path #2, etc.), association criteria (e.g., AoA) and reference measurement(s) (e.g., AoAs, associated with the path ID(s)).

The WTRU may perform path measurement(s) with the reference DL-PRS ID(s) and measures the RSRPP and AoA of the multipath components.

The WTRU may associate a path measurement with a reference path and allocates the reference path ID to the measurement based on at least one of the following: the measured RSRPP of the path is above the (pre) configured RSRPP threshold, the difference between the AoA of the path and a reference AoA measurement is below the (pre) configured AoA_difference threshold.

The WTRU may report the path ID, the updated measurement (e.g., most recent measurement associated with the path ID) and timestamp of measurement to the network.

### Measurement and Reporting Configuration

In certain representative embodiments, the WTRU may receive one or more set(s) of DL-PRS configuration(s) and/or measurement configuration(s) and/or reporting configurations from the network for the first procedure and the second procedure. In certain representative embodiments, the configurations may be received based on the request from the WTRU. The WTRU may send the request to the network for the configuration(s) in the uplink physical channels, e.g., PUSCH or PUCCH, via higher layer signaling e.g., MAC-CE or RRC, or via LPP messages.

### DL-PRS Configurations:

In certain representative embodiments, the WTRU may receive the DL-PRS configurations in the downlink physical channels, e.g., PDSCH or PDCCH, via higher layer signaling e.g., MAC-CE, RRC, DCI or via LPP messages from the network. In certain representative embodiments, the WTRU may receive more than one set(s) of DL-RS configuration. Each configuration may be indicated with a configuration ID (e.g., DL-PRS ConfigID). In one example, the configuration(s) may correspond to one or more TRP(s). Each configuration may be associated with one or more TRP index (e.g., TRP ID). In one example, the configurations may be on-demand configurations (e.g., for sensing).

### Measurement Configurations:

In certain representative embodiments, the WTRU may receive one or more measurement configurations from the network in the downlink physical channels, e.g., PDSCH or PDCCH, via higher layer signaling e.g., MAC-CE, RRC, DCI or via LPP messages from the network. Each measurement configuration may be associated with a measurement configuration index (e.g., MeasConfig ID). In certain representative embodiments, the measurement configuration ID may be associated with a DL-PRS configuration ID.

### Reporting Configurations:

In certain representative embodiments, the WTRU may receive one or more reporting configurations from the network in the downlink physical channels, e.g., PDSCH or PDCCH, via higher layer signaling e.g., MAC-CE, RRC, DCI or via LPP messages from the network. Each reporting configuration may be identified with a reporting configuration index (e.g., ReportConfig ID). In one example, one or more reporting configuration(s) may be associated with one or more DL-PRS and/or measurement configuration(s).

In certain representative embodiments, the WTRU may receive the configuration(s) (e.g., DL-PRS configuration(s) and/or measurement configuration(s) and/or reporting configuration(s)) for the first procedure as the first configuration (e.g., first DL-PRS configuration, first measurement configuration and/or first reporting configuration) and the second procedure as the second configuration (e.g., second DL-PRS configuration, second measurement configuration and/or second reporting configuration).

In certain representative embodiments, the difference between first and second procedure may be in terms of sensing configurations (e.g., first configuration and second configuration), the WTRU behaviour (e.g., measurement behaviour, reporting behaviour), signalling from the network to the WTRU or vice versa, etc.

In certain representative embodiments, the WTRU may be configured or may determine the configuration as for either first or second procedure based on:

i) Explicit indication, e.g., the WTRU may receive a message indicating a subset of configuration ID(s) are associated with first procedure and rest are associated with second procedure.

ii) purpose of configuration, e.g., a) the WTRU may determine a first procedure for a target object detection, whereas a second procedure for target object tracking, b) the WTRU may determine a first procedure for a target object detection, whereas a second procedure for environment monitoring, c) the WTRU may receive configuration(s) (e.g., activation, indication, etc.) via lower layer signalling (e.g., DCI, MAC-CE) for the second procedure, whereas higher layer messages (e.g., RRC) otherwise, d) the WTRU may report measurements with lower or higher layer signalling (e.g., DCI, MAC-CE) in the second procedure, whereas uplink physical channel (e.g., PUSCH, PUCCH, etc.), otherwise, e) the WTRU may determine a first procedure if it makes path measurements and reporting without a reference and second procedure otherwise, etc.

iii) configuration ID(s) (e.g., DL-PRS ID(s), measurement configuration ID(s), reporting configuration ID(s)). The WTRU may receive indication(s) via configuration ID(s) from the network to differentiate between first or second procedure, where, for e.g., a set of ID(s) may be associated with first and another set with the second procedure.

iv) configuration parameters, e.g., first procedure associated with a) bandwidth below a (pre) configured threshold and second procedure otherwise, b) aperiodic DL-PRS configuration(s) and periodic for the second procedure, c) an event-triggered reporting configuration(s) and second procedure otherwise, d) no time window activation, and second procedure otherwise, etc.,

v) State of the WTRU, e.g., a) the WTRU may determine a first procedure if in a power saving mode, and second procedure otherwise, b) the WTRU may determine a first procedure if in a certain RRC state (e.g., RRC IDLE), and second procedure otherwise (e.g., RRC CONNECTED), c) the WTRU may determine a first procedure if it is mobile, and second procedure otherwise.

vi) Number of path(s) to measure. The WTRU may be configured for a first procedure if the number of path(s) to monitor or measure is above a threshold and second procedure otherwise.

vii) QoS requirement, e.g., the WTRU may determine a first procedure if the QoS requirement (e.g., accuracy requirement, latency requirement, etc.) is below a (pre) configured threshold, and a second procedure otherwise.

In certain representative embodiments, the first configuration may indicate to first set(s) of DL-PRS configuration(s), measurement configuration(s) and/or reporting configuration(s) for one purpose such as object detection, whereas second configuration may indicate to second set(s) of DL-PRS configuration(s), measurement configuration(s) and/or reporting configuration(s) for second purpose such as object tracking.

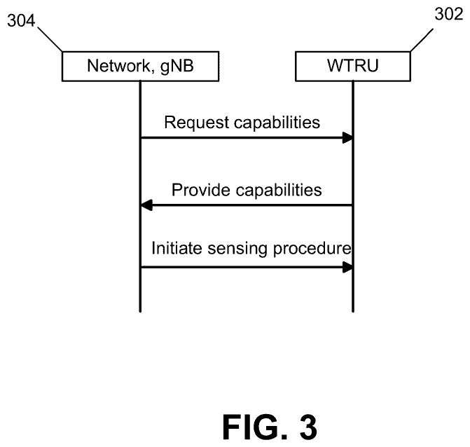

FIG. 3 illustrates a procedure to request and report capabilities according to one or more embodiments. A WTRU 602 may receive a request to provide capability information from a network 604 for receiving, measuring and/or reporting for first and/or for second procedures from the network 604.

The WTRU 602 may report its capability unsolicited, for e.g., based on the request from the network 604 or as a part of initial access procedure. The WTRU 602 may report at least one of the following:

i) Measurement capabilities, e.g., a) capability to perform measurement(s) on a certain DL-RS(s) (e.g., SSB, CSI-RS, DL-PRS, b) capability to perform per path measurements (e.g., AoA per path, RSRPP, carrier phase per path, etc.), c) maximum measurement periodicity, granularity etc., d) maximum number of DL-PRS resource(s) the WTRU 602 may monitor, e) maximum number of frequencies (e.g., in terms of frequency range, Hz, MHz, bandwidth, positioning frequency layers, no. of resource elements (REs), no. of resource blocks (PRB)) the WTRU is capable of measuring, f) maximum number of number of paths (e.g., n paths), target objects (e.g., n objects) capable of measuring, g) maximum sensing range (e.g., in terms of meters), sensing AoA range (e.g., in terms of degrees, radians, etc. with respect to a reference direction), etc., h) receive beam capability (e.g., beamwidth, no. of beams, AoDs of the receive beams).

ii) Reporting capability, e.g. a) maximum reporting periodicity, b) maximum no. of paths capable of reporting (e.g., n paths), c) maximum number of frequencies (e.g., in terms of frequency range, bandwidth, Positioning Frequency Layers (PFLs), no. of REs, no. of PRB) the WTRU 602 is capable of reporting etc.

iii) Capability associated for the second procedure, e.g. a) maximum no. of measurement occasions, the WTRU may acquire and store measurement(s) for, b) maximum no. of paths (e.g., n paths), target objects (e.g., n objects), etc. the WTRU may monitor at an instance, c) maximum duration between consecutive signalling (e.g., lower or higher layer signalling (e.g., DCI, MAC-CE, RRC, etc., in terms of no. of symbols, slots, frames, sub-frames, seconds, milliseconds, etc.).

The WTRU 602 may receive an indication to initiate first and/or second sensing procedure after capability transfer.

### Assistance Information for Sensing

In certain representative embodiments, a WTRU may receive assistance information for sensing a target object from a network. The WTRU may receive assistance information associated with first and/or second configuration from the network via downlink physical channel (e.g., PDSCH, PDCCH, etc.) or via lower or higher layer signalling (e.g., DCI, MAC-CE, RRC or LPP message).

In certain representative embodiments, the assistance information may consist of at least one of the following:

i) Assistance information ID. In certain representative embodiments, the WTRU may receive one or more set(s) of assistance information(s) where each set is identified by an index, e.g., Assistance ID(s). Each set may contain at least one or more assistance information for first and/or second procedure.

ii) Association of assistance information with first and/or second configuration(s)._In certain representative embodiments, the WTRU may receive one or more combinations of the assistance information. The assistance information may be either be common or specific to either first and/or second configuration. In certain representative embodiments, the WTRU may receive assistance information with associations to the first and/or second configuration. The assistance information may have a reference to the associated configuration(s), e.g., as DL-PRS ID(s), DL-PRS configuration ID(s), measurement configuration ID(s), reporting configuration ID(s), etc. In In certain representative embodiments, at least one of the DL-PRS configuration, measurement configuration, and/or reporting configuration may have an association with at least one assistance information.

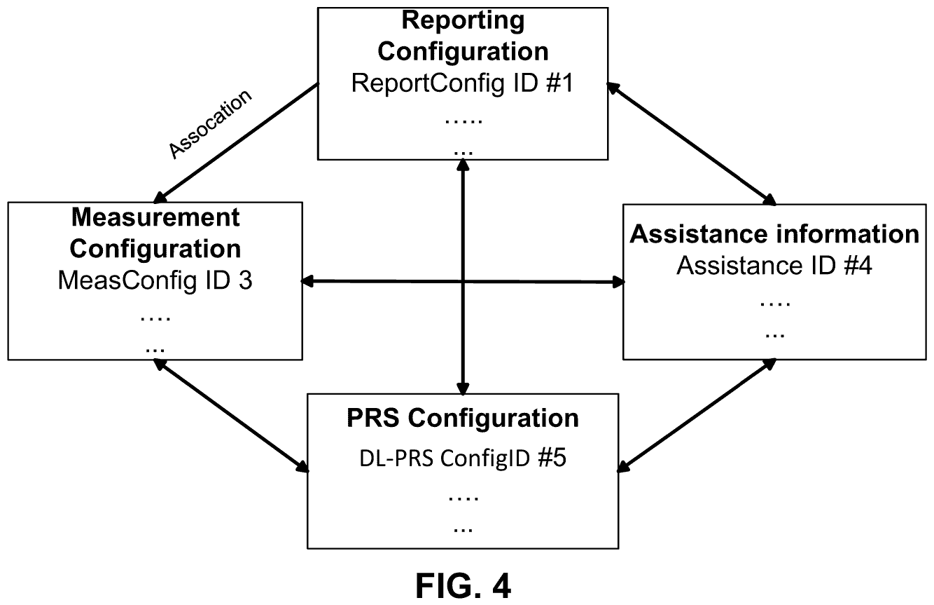

In certain representative embodiments, each of the configuration(s) and/or assistance information may have a reference to other configuration(s) and/or assistance information. FIG. 4 illustrates an association between configuration(s) and assistance information according to one or more embodiments. For example, the Assistance ID #4 may have a field with reference to MeasConfig ID #3, ReportConfig ID #1 and DL-PRS ID #5. In certain representative embodiments, the association between configuration(s) and/or assistance information may be between the configurations and assistance information associated with the same procedure (e.g., first and/or second procedure). In certain representative embodiments, the association may determine if the configuration and/or assistance information is intended for first or second configuration.

iii) Reference DL-PRS ID. In certain representative embodiments, the WTRU may receive one or more reference DL-PRS ID(s) (e.g., a subset of configured DL-PRS ID(s)) from the network. The reference DL-PRS ID(s) may be associated with one or more DL-PRS resource set ID(s). In certain representative embodiments, the WTRU may receive one or more reference angles of boresight direction(s) (e.g., reference azimuth of boresight, reference zenith of boresight)) indicating the DL-PRS ID(s) to monitor. The WTRU, in certain representative embodiments, may associate the reference angles(s) with one or more DL-PRS ID(s).

In certain representative embodiments, the reference DL-PRS ID may either be associated with the first procedure or the second procedure. The WTRU may receive the indication via at least one of the following ID(s): DL-PRS ID(s), TRP ID(s), TCI-State ID(s), AoD and/or ZoD of the boresight direction.

iv) Reference AoA indication. In certain representative embodiments, the WTRU may receive AoA indication(s) (e.g., in terms of degrees, radians) with respect to a reference as assistance information. In certain representative embodiments, the WTRU may receive the AoA indication in terms of azimuth or zenith AoA. In certain representative embodiments, an AoA indication may be in terms of at least one of the following:

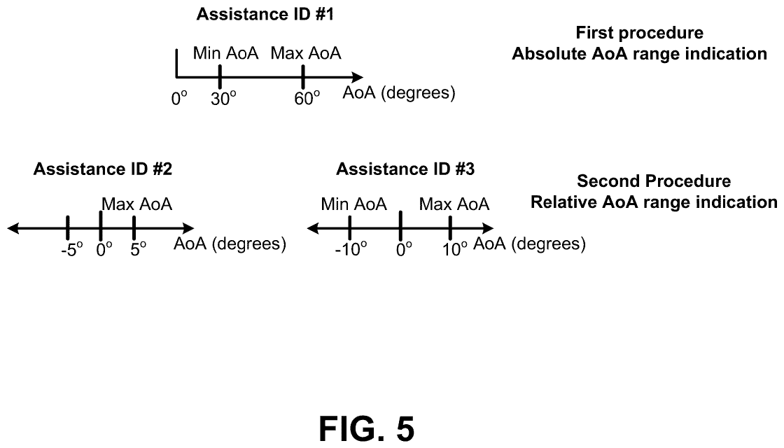

a) Absolute AoA range (e.g., min AoA, max AoA, AoA range). FIG. 5 illustrates an absolute and relative AoA range indication(s) according to one or more embodiments. The absolute and relative AoA range indication(s) may be for first and second procedure respectively. In certain representative embodiments, as illustrated in FIG. 5, the WTRU may receive AoA range in terms of a minimum and a maximum value (e.g., in terms of degrees or radians). In certain representative embodiments, the WTRU may receive a min AoA and an AoA range (e.g., in terms of degrees or radians) to indicate the absolute AoA range.

b) Relative AoA range. In certain representative embodiments, as illustrated in FIG. 5, the WTRU may receive relative AoA range (e.g., in terms of degrees, radians, etc.). As illustrated in FIG. 5, the relative AoA range may be 10 degrees (e.g., between −5 and 5 degrees) for the Assistance ID #2 and 20 degrees (e.g., between −10 and 10 degrees) for the Assistance ID #3.

In certain representative embodiments, the WTRU may receive an indication of the reference for the relative AoA including at least one of the following: expected AoA value (e.g., indicated by the network), AoA value (e.g., average, median) in the previous measurement occasion(s), for example, the AoA value of the n-th path in the previous measurement occasion etc.

In certain representative embodiments, the AoA range relative to previous measurement occasion may be associated with the second configuration.

c) Reference for AoA indication. In certain representative embodiments, the AoA (e.g., absolute AoA, AoA range, etc.) may be indicated by the network with respect to a reference direction where the reference may be at least one of the following: global coordinate system such as geographical north, local coordinate system such as WTRU orientation (e.g., in terms of Euler angles, radians, degrees, etc.), AoA of the direct path associated with a TRP (e.g., reference TRP, serving cell), UL RS ID (e.g., SRSp ID, SRS ID) (e.g., associated with path-loss measurement, DL RS reception, etc.) and/or the reference angle associated with the UL RS ID, DL RS ID (e.g., DL-PRSID, CSI-RS ID, pathloss DL-RS) (e.g., associated with path-loss measurement, etc.) and/or the reference angle associated with the DL RS ID.

v) Relative time delay indication. In certain representative embodiments, the WTRU may receive a relative time delay indication (e.g., in terms of number of symbols, slots, frames, sub-frames, milliseconds, seconds etc.) from the network as an assistance information. The WTRU may receive at least one of the following:

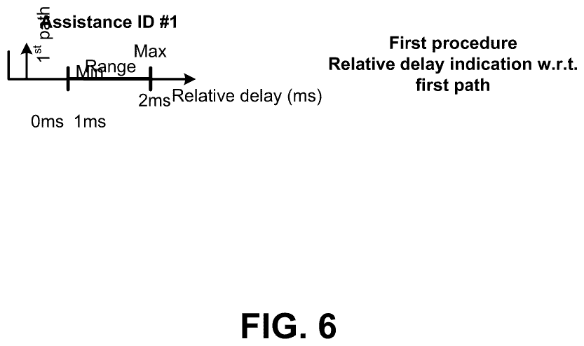

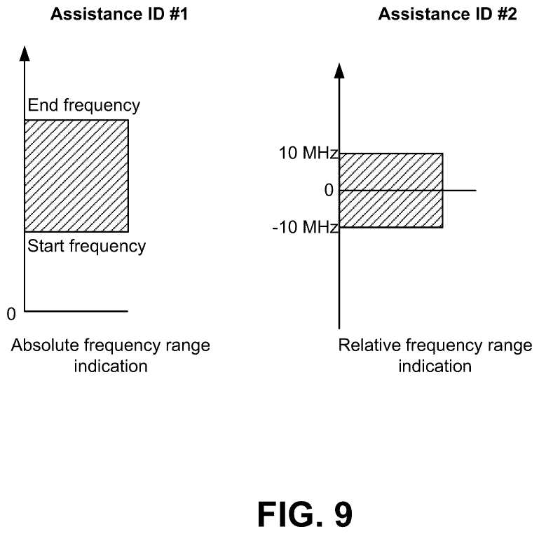

a) Relative delay indication (e.g., minimum relative delay, maximum relative delay, relative delay duration). FIG. 6 illustrates a relative delay range indication between minimum and maximum according to one or more embodiments. In certain representative embodiments, as illustrated in FIG. 6, the WTRU may receive at least one of the minimum relative delay, maximum relative delay, relative delay duration, etc. from the network. The relative delay range may be with respect to a reference time where the reference may be at least one of the following: Time of arrival (ToA) of the first detected path of a received DL-PRS (e.g., as illustrated in FIG. 9), transmission time of a received DL-PRS, ToA of the first detected path of a reference DL-PRS ID, transmission time of a received DL-PRS ID, System Frame Number 0 (SFN0) offset (e.g., with additional associated symbol, slot, subframe, frame offset), relative time delay measurement(s) (e.g., average) in the previous measurement occasion(s), expected relative delay (e.g., indicated by the network).

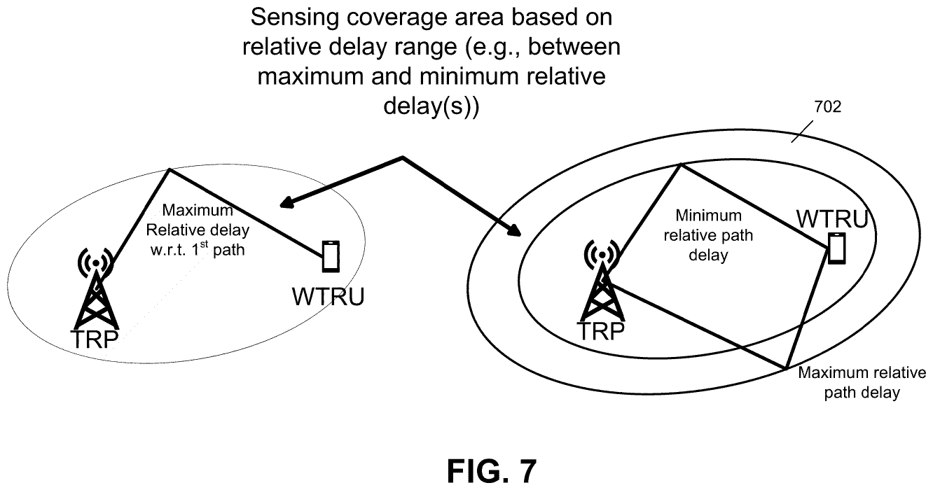

FIG. 7 illustrates a sensing coverage area determined based on maximum and minimum relative delay range(s) according to one or more embodiment. In certain representative embodiments, as illustrated in FIG. 7, the relative delay range indication may indicate an area (shaded region 702 in FIG. 7). The area may be the whole ellipse (e.g., determined based on TRP and WTRU location(s) as foci and relative delay with respect to the first path as distance between the circumference point and the foci) if the minimum relative delay if the delay of the first path (e.g., left figure of FIG. 7) or the difference of ellipse (e.g., right figure of FIG. 7).

In certain representative embodiments, the relative time delay measurement(s) in the previous measurement occasion may be associated with the second configuration. For e.g., if the maximum relative delay range was X ms with respect to the first path in the previous occasion and the WTRU is configured with Y ms with respect to the previous occasion, the WTRU may determine that the range may be Y+X ms with respect to the first path in the current occasion.

b) Expected relative delay: In certain representative embodiments, the WTRU may receive expected relative delay from the network. The expected relative delay may be with reference to the references as indicated in the relative delay range.

vi) Measurement thresholds (e.g., RSRPP, Doppler shift threshold): In certain representative embodiments, the WTRU may be configured with measurement threshold(s) e.g., RSRPP threshold(s) (in terms of dBm, watt) and/or Doppler shift threshold(s) (e.g., in terms of Hz).

The RSRPP threshold may be an absolute threshold or a relative threshold. The relative RSRPP threshold may be configured relative to at least one of the following references: a) Measured RSRPP of the n-th path (e.g., first path), b) Reference RSRPP value (e.g., X dBm), c) RSRPP value(s) (e.g., average, median, etc.) of the path(s) in the previous measurement occasion(s).

In certain representative embodiments, the RSRPP threshold may indicate an area (e.g., sensing coverage area) indicating the object location region(s) where the reflection may result in a measured RSRPP of above a certain threshold.

The Doppler shift threshold may be an absolute threshold or a relative threshold. The relative Doppler shift threshold may be configured relative to at least one the following references: a) Measured Doppler shift of the n-th path (e.g., first path), b) Reference Doppler shift value (e.g., X Hz), c) Doppler shift value(s) (e.g., average, median, etc.) of the path(s) in the previous measurement occasion(s).

In certain representative embodiments, the relative measurement threshold(s) with respect to the measurements in the previous occasions may be associated with the second configuration.

The WTRU may also be configured with expected RSRPP and/or expected Doppler shift values from the network.

vii) Reference location(s) (e.g., of sensing object(s), PRU(s), neighbouring TRP(s), neighbouring UE(s)): In certain representative embodiments, the WTRU may receive the reference location(s) of one or more sensing object(s), PRU(s), neighbouring TRP(s), neighbouring WTRU(s). In certain representative embodiments, each location may be an absolute location or a relative location. If the location is a relative location, the WTRU may receive the reference point associated with the object. The reference may be at least one of the following WTRU location, PRU location, TRP location (e.g., TRP ID), etc.

In certain representative embodiments, if the WTRU receives a reference location (e.g., 3D location, 2D location, etc.), the WTRU may determine to represent the location in terms of the positioning metrics (e.g., angle between the WTRU and the object (zenith, azimuth), difference between the gNB to WTRU distance and/or delay and the gNB to reference location to the WTRU distance and/or delay, etc.). In certain representative embodiments, the WTRU may determine to use the same reference as configured with the sensing assistance information (e.g., of reference AoA and/or reference relative time delay) while changing the representation.

In certain representative embodiments, only PRU, a WTRU with known location by the network, may be able to perform sensing. In certain representative embodiments, the WTRU may receive a request to report the WTRU capability to the network. The WTRU may indicate, in the WTRU capability report, that the WTRU is a PRU or PRU ID. The WTRU may report its location to the network. If the WTRU determined the location, the WTRU may determine to indicate the positioning method used to determine the location (e.g., Radio Access Technology (RAT) dependent positioning method, RAT independent positioning method such as GPS, GNSS).

In certain representative embodiments, the reference location may be a reference area (e.g., indicated as assistance information in terms of coarse location or a zone ID). The reference area may be represented as at least one of the following: a) Coarse location (e.g., ellipsoid point with uncertainty region), b) Zone ID, c) any other representation of a geographical area.

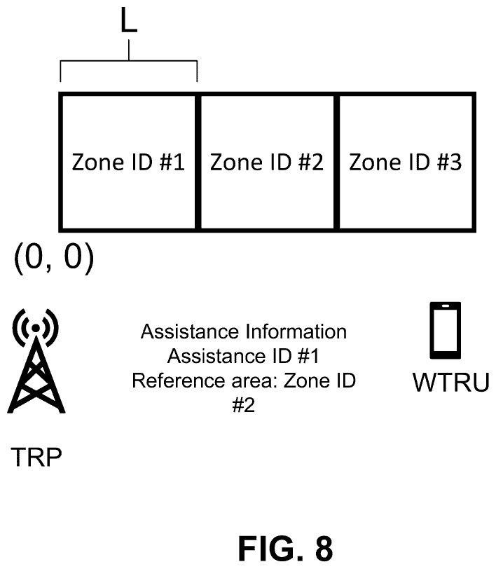

FIG. 8 illustrates zone ID(s) with a zone length L configured by a network according to one or more embodiments. An indication of the zone ID #2 as a reference by the network may indicate the area associated with first and/or second procedures. In certain representative embodiments, the WTRU may also be configured with mapping or formula to translate the indicated zone ID to a geographical area.

In certain representative embodiments, the WTRU may receive a sequence of reference location(s) and or reference area(s) indicating the expected trajectory of the target object. Each of the location(s) and/or references may be associated with a time indication. For example, the WTRU may receive a sequence of [Zone ID #1, Zone ID #2, Zone ID 3] indicating the object may be moving from Zone ID #1 to Zone ID #3. The WTRU may also receive a relative time duration of 3 seconds for Zone ID #2 and 2 seconds for Zone ID #3, with respect to Zone ID #1. This may indicate that the UE may determine Zone ID #2 as a reference location 3 seconds after activating Zone ID #1 and Zone ID #3 2 seconds after activating Zone ID #2.

The reference location and/or area may indicate the WTRU to perform measurement(s) for first and/or second procedure in the location and/or area.

viii) Location of the UE: In certain representative embodiments, the WTRU may receive the locations of the WTRU which may be associated with the assistance information. In certain representative embodiments, the location may indicate the conditions to activate the assistance information and/or the configurations (e.g., DL-PRS configuration, measurement configuration, reporting configuration, etc.) associated with it. In one example, the location may be indicated to the WTRU in terms of an area (e.g., coarse location, zone ID, etc.).

ix) UE mobility: In certain representative embodiments, the WTRU may be configured with the mobility conditions associated with the assistance information and/or the configurations (e.g., DL-PRS configuration, measurement configuration, reporting configuration, etc.) associated with it. In one example, the WTRU mobility may be indicated to the WTRU in terms of at least one of the following: Velocity threshold (e.g., in terms of meters/seconds), Doppler shift threshold (e.g., in terms of Hz).

x) Reference path ID: In certain representative embodiments, the WTRU may receive one or more reference path indices (e.g., path ID #1, path ID #2) from the network. In certain representative embodiments, the WTRU may receive the reference path ID in terms of a path identity, a path index, a path group index. The WTRU may also receive the reference to the reference path #ID as at least one of the following: Cell ID and/or TRP ID, PRS resource ID and/or DL-PRS resource set ID, SRSp resource ID and/or SRSp resource etc.

xi) Reference frequency indication: In certain representative embodiments, the WTRU may receive a frequency indication from the network. The indication may be in terms of at least one of the following:

a) Absolute frequency range (e.g., start frequency, end frequency, in terms of Hz, RE, PRB, PFL, BWP etc.). In certain representative embodiments, the WTRU may receive the minimum and maximum frequency and may determine to perform measurement(s) based on the measurement(s) associated with the indicated frequency.

b) Relative frequency range (e.g., expected frequency, frequency range). In certain representative embodiments, the WTRU may receive a relative frequency range (e.g., in terms of Hz, no. of REs, no. of Resource Blocks (RBs), etc.) where it may perform sensing measurement. In certain representative embodiments, the relative frequency range may be with respect to an expected frequency (e.g., in terms of Hz, RE, PRB, etc.) indicated by the network. In certain representative embodiments, the expected frequency may be the frequency associated with the path measurement(s) in the previous measurement occasion(s).

FIG. 9 illustrates absolute and relative frequency indications according to one or more embodiments. In certain representative embodiments, as illustrated in FIG. 9, absolute frequency indication is associated with Assistance ID #1 and relative frequency indication is associated with Assistance ID #2. For relative frequency indication, the frequency range is 20 MHz (e.g., between −10 and 10 MHZ) and may be associated with a reference frequency (e.g., expected frequency) such that the WTRU may perform measurements on frequency range of reference frequency ±10 MHZ.

In certain representative embodiments, the absolute frequency range may be associated with the first procedure and relative frequency range may be associated with the second procedure.

### First Measurement and Reporting Procedures

In certain representative embodiments, the WTRU may be configured by the network to perform measurement(s) and/or determine the path ID(s) and/or report the measurement(s), etc. for the first procedure, e.g., based on the first configuration and first assistance information.

In certain representative embodiments, the UE may be configured with and/or may determine the (e.g., subset of (pre) configured) DL-PRS resource(s) and/or DL-PRS beam(s) (e.g., reference DL-PRS ID(s)) to perform measurement for the first procedure on based on at least one of the following: a) Reference DL-PRS resource ID(s) or beam ID(s), b) PRS resource ID(s) and/or DL-PRS beam ID(s) with beam direction(s) spatially aligned towards the reference locations, c) PRS resource ID(s) and/or DL-PRS beam ID(s) spatially aligned with the sensing coverage region (e.g., an ellipse) defined by the TRP location, UE location and at least one of relative delay indication (e.g., relative delay range, expected relative delay, etc.) and RSRPP threshold. d) PRS resource ID(s) and/or DL-PRS beam ID(s) with measurement(s) (e.g., RSRPP (e.g., average), RSRP, delay spread, Doppler spread, etc.) above a (pre) configured threshold etc.

In certain representative embodiments, the condition(s) for the UE to determine DL-PRS configuration(s) (e.g., for first and/or second procedure) for measurement may also be the condition(s) to determine the which TRP(s) to select and make measurement(s) on. The DL-PRS resource ID(s) and/or beam ID(s) may be associated with one or more TRPs.

In certain representative embodiments, the WTRU may be configured and/or may determine the direction of the receive beam for measurement and/or based on following parameters of the first assistance information:

a) AoA indication (e.g., absolute AoA range, relative AoA range). E.g., i) the receive beam spatially aligned with respect to the absolute AoA range (e.g., between minimum AoA and maximum AoA). E.g., ii) the receive beam spatially aligned to the reference associated with the relative AoA range (e.g., with respect to the expected AoA indicated by the network), etc.

b) Relative delay indication. E.g., i) receive beam spatially aligned to the area indicated by a relative delay indication. E.g., ii) receive beam spatially aligned based on the sensing coverage area determined by the difference of ellipse with TRP and UE location as foci points and the major and minor axis defined by the relative time delay and/or RSRPP threshold) (e.g., as illustrated in FIG. 7).

c) RSRPP thresholds. E.g., based on the area determined by the difference of ellipse with TRP and UE location as foci points and the major and minor axis defined by the or RSRPP threshold.

d) Expected Doppler shift measurements. E.g., based on the direction of object mobility determined based on expect Doppler shift measurements.

c) Reference location. E.g., in the direction of the reference location (e.g., reference location, reference area (e.g., Zone ID, coarse location), etc.) indicated by the network.

f) The direction of the reference path. E.g., i) based on spatial filter associated with reception of DL RS associated with the reference path, reference DL-PRS ID, etc. e.g., ii) based on measurements (e.g., AoA) associated with the reference path ID, e.g., iii) based on the spatial relationship between a receive beam with UL RS and/or DL RS associated with the reference path ID, etc.

g) Spatial information of a RS (e.g., reference DL-RS). E.g., based on spatial direction used to receive or transmit other RSs (e.g., DL RS such as SSB, CSI-RS, DL-PRS, etc., UL RS such as SRS, SRSp, etc.) (e.g., indicated to the UE via configured spatial relationship information, or QCL relationship).

In certain representative embodiments, the WTRU may be configured with and/or may determine the beamwidth of the receive beam for the first measurement configuration based on at least one of the following:

a) the beamwidth of the reference DL-PRS ID(s).

b) the AoA range indication (e.g., difference between the maximum and minimum AoA(s), in terms of degrees, radians, etc.).

c) the reference location, e.g., i) the uncertainty associated with the reference location (e.g., indicated by the network) and/or the reference area (e.g., uncertainly of the ellipsoid point associated with the coarse location, area of the reference area etc.), e.g., ii) the configured dimension (e.g., length) of the zone ID, etc.

d) expected Doppler shift measurement and/or indicated object and/or UE velocity, etc.

In certain representative embodiments, the WTRU may be configured and/or may determine to perform the measurements and/or allocate path ID(s) to the measurement(s) within a time range. The time range can be indicated by the relative delay indication. For example, the WTRU may perform measurements between the minimum and maximum relative delay (e.g., with reference to the first arrival path).

In certain representative embodiments, the WTRU may be configured or may determine to perform measurement and/or allocate path ID(s) to the (pre) configured reference path(s) e.g., k-th path (e.g., 1st path, 3rd path, etc.).

In certain representative embodiments, the WTRU may perform measurements and/or allocate path ID(s) based on configured frequency indices or intervals, e.g.,

a) between start frequency and end frequency (e.g., in terms of PRB index, RE index, Hz, kHz, MHz, etc.).

b) within the relative frequency range around the configured reference (e.g., expected frequency range).

c) PFL (e.g., PFL ID(s)).

d) bandwidth (e.g., in terms of BWP ID, PFL ID, Hz, kHz, MHz etc.).

In certain representative embodiments, the WTRU may perform measurement(s) if its velocity is below a (pre) configured threshold. In certain representative embodiments, the WTRU may perform measurement(s) if it has its location information and/or the uncertainty of its location information is below a (pre) configured threshold.

In certain representative embodiments, the WTRU may be configured with and/or may determine the parameters of measurement configuration (e.g., periodicity) based on at least one of the following parameters (e.g., associated with first procedure, first configuration and/or first assistance information):
a) Periodicity of the (pre) configured DL-PRS resource(s)
b) Location and/velocity of the UE
c) indicated relative delay range (e.g., maximum relative delay)
d) indicated RSRPP threshold
c) indicated Doppler shift threshold or expected Doppler shift
f) the distance between the WTRU and the reference location
g) the distance between the TRP and the reference location
g) the measurement(s) (e.g., RSRPP, AoA) associated with object or a path, etc.

In certain representative embodiments, the WTRU may determine one set of parameters if at least one of the above factors is below a (pre) configured threshold and another otherwise.

In certain representative embodiments, the WTRU may be configured by the network with event-based reporting for the first procedure. In certain representative embodiments, the WTRU may be configured by the network with at least one or a combination of the following conditions in order to report to the network:

a) The measurements of a path (e.g., reference path ID), e.g., RSRPP measurement(s) and/or Doppler shift measurements, etc. are above a (pre) configured threshold.

b) The measurements of a received DL-PRS resource/PRS ID (e.g., reference DL-PRS ID) is above a (pre) configured threshold, e.g., ii) Measured RSRP of a DL-PRS resource ID and/or DL-PRS ID is above a (pre) configured threshold, iii) Measured Doppler shift of a DL-PRS resource ID and/or DL-PRS ID is above a (pre) configured threshold, iv) Measured delay spread of a DL-PRS resource ID and/or DL-PRS ID is above a (pre) configured threshold, v) Measured RSRPP (e.g., average, first N paths, etc.) of a DL-PRS resource ID and/or DL-PRS ID is above a (pre) configured threshold.

c) The difference between the measurements of a path, e.g., the reference path ID, (e.g., between N measurement occasions, where N may be configured by the network) is above a (pre) configured threshold, for example, i) Difference between the RSRPP measurement and/or Doppler shift measurement of the reference path ID compared to previous occasion is above a (pre) configured threshold, ii) Difference between the Doppler shift measurement of a path compared to the average of 5 previous occasion(s) is above a (pre) configured threshold.

d) The difference between the measurements of a received DL-PRS resource/PRS ID (e.g., reference DL-PRS ID) compared to N previous measurement occasions (E.g., where N is configured by the network) is above a (pre) configured threshold, e.g., i) Difference between the measured RSRP of a DL-PRS resource ID and/or DL-PRS ID compared to average of previous 3 occasions is above a (pre) configured threshold, ii) Difference between measured Doppler shift of a DL-PRS resource ID and/or DL-PRS ID compared to previous occasion is above a (pre) configured threshold.

c) The number of path(s) between the (pre) configured AoA range(s) indication (e.g., minimum and maximum AoAs) is above a (pre) configured threshold.

f) The measured path (e.g., reference path ID) is between the (pre) configured AoA range(s) indication (e.g., minimum and maximum AoAs).

g) The measurement(s) (e.g., RSRPP, Doppler shift, etc.) associated with the path(s) (e.g., reference path ID) between the AoA range (e.g., minimum and maximum AoAs) is above a (pre) configured threshold, for example, i) The measured RSRPP of the path(s) within the AoA range is above a (pre) configured threshold, ii) The measured Doppler shift of the path(s) within the AoA range is above a (pre) configured threshold, iii) The measured relative delay (e.g., with respect to the first path) of the path(s) within the AoA range is below a (pre) configured threshold (e.g., same reference as the measurement).

h) The difference between the measured AoA of a path and the (pre) configured expected AoA is below a (pre) configured threshold.

i) The number of path(s) within the relative delay range (e.g., minimum and maximum relative delay) is above a (pre) configured threshold.

j) The measured path(s) (e.g., reference path ID) is within the relative delay range (e.g., minimum and maximum relative delay) is above a (pre) configured threshold.

k) The measurement(s) (e.g., RSRPP, Doppler shift) associated with the path(s) (e.g., reference path ID) between the relative delay range (e.g., minimum and maximum relative delays) is above a (pre) configured threshold, for example, i) The measured RSRPP of the path(s) within the relative delay range is above a (pre) configured threshold, ii) The measured Doppler shift of the path(s) within the relative delay range is above a (pre) configured threshold.

l) The number of path(s) measured in the (pre) configured frequency indication(s) (e.g., within the frequency range (e.g., minimum and maximum frequency), expected frequency) is above a (pre) configured threshold.

m) The measurement(s) of the path(s) (e.g., reference path ID) is within the (pre) configured frequency range indication (e.g., within the frequency range (e.g., minimum and maximum frequency), expected frequency).

n) The measurement(s) (e.g., RSRPP, Doppler shift, etc.) performed in the (pre) configured frequency indication (e.g., within the frequency range (e.g., between start and end frequency), expected frequency) is above a (pre) configured threshold, for example, i) The measured RSRPP of the path(s) within the frequency range is above a (pre) configured threshold ii) The measured Doppler shift of the path(s) within the frequency range is above a (pre) configured threshold, iii) The measured relative delay of the path(s) (e.g., with reference to the first path) is within the frequency range is below a (pre) configured threshold.

o) The measurement(s) (e.g., relative delay, AoA, etc.) correspond to the (pre) configured reference location, for e.g., i) The measured path is within the AoA range and/or relative delay determined by the WTRU location and/or the reference location, ii) The measured RSRPP and/or Doppler shift of the path(s) associated with the reference location is above a (pre) configured threshold, etc.

p) The WTRU and/or object is located in a (e.g., reference) location and/or reference area (e.g., coarse location, zone ID, etc.).

In certain representative embodiments, the WTRU may report if it determines that its location is in one of the (pre) configured geographical area such as an indicated coarse location or a zone ID.

In certain representative embodiments, the WTRU may receive or determine the object location and may determine to report if the object location is in one of the (pre) configured geographical areas such as a coarse location or a zone ID.

In certain representative embodiments, the WTRU may report if both the object and the WTRU is in the (pre) configured geographical area(s) such as coarse location and/or zone ID(s).

In certain representative embodiments, the geographical area for WTRUWTRU and/or object location may be associated with the reporting configuration.

p) The velocity of the WTRU and/or the object is above a (pre) configured threshold.

q) The duration between a reference time and the time instance when the trigger is met is below a (pre) configured threshold, where the reference time may be at least one of the i) time instance when the WTRU receives the first configuration(s), ii) time instance when the WTRU receives the DL-PRS resource(s), etc.

In certain representative embodiments, the conditions and event(s) described above for event triggered reporting may also be the conditions for WTRU to determine the path ID(s) for tracking and may report to the network.

In one solution, the WTRU may be configured with periodic configuration(s) for the first reporting procedure. The WTRU may be configured with the first reporting interval, first no. of measurement reports, etc. The WTRU may report periodically to the network based on the first reporting configuration.

In certain representative embodiments, the WTRU may determine the periodic reporting parameters (e.g., reporting intervals, report amount, etc.) based on at least one of the following: a) The periodicity of the (pre) configured DL-PRS resource(s).

b) The periodicity of the measurement(s) (e.g., based on measurement configuration).

c) The location and/velocity of the WTRU for example, if the WTRU is located in a reference location and/or reference area associated with a certain reporting interval.

d) The indicated relative delay range (e.g., maximum relative delay) is below a (pre) configured threshold.

e) The indicated RSRPP threshold is below a (pre) configured threshold.

f) The indicated Doppler shift threshold and/or the expected Doppler shift value is above a (pre) configured threshold.

g) The distance between the WTRU and the reference location is below a (pre) configured threshold.

h) The distance between the TRP and the reference location is below a (pre) configured threshold.

i) The measurement(s) (e.g., RSRPP, AoA) associated with object or a path is above a (pre) configured threshold, etc.

j) The difference between the measurement(s) (e.g., RSRPP, AoA, relative delay, AoA, etc.) between measurement occasion(s) is above a (pre) configured threshold, etc.

In certain representative embodiments, the WTRU may be configured by the network to report (e.g., based on the first configuration) at least one of the following:

a) Path ID(s) for tracking (e.g., measured path(s) meeting one or a combination of the conditions and trigger events as described for event-based reporting).

b) Measurement(s) associated with the path ID(s), for example, multipath measurements (RSRPP, AoA, delay spread, Doppler shift, Doppler spread, etc.).

c) Satisfied conditions and/or the trigger events.

d) Path association criteria (e.g., AoA, relative delay, etc.).

c) DL-PRS resource(s) ID(s) and/or DL-PRS ID(s) and/or DL-PRS resource set ID(s) associated with the path measurement(s).

f) Association UL-RS resource(s) ID(s) and/or UL-RS ID(s) and/or UL-RS resource set ID(s) associated with the path measurement(s).

g) Measured path ID(s) (e.g., not satisfying the one or more condition(s) and/or the event trigger conditions).

h) Measurement(s) associated with path ID(s) (e.g., paths not satisfying the one or more condition(s) and/or the event trigger conditions).

i) Uncertainties associated with the measurement(s).

j) TRP(s)/Cell ID(s) associated with the measurement(s).

k) Timestamp associated with the measurements (e.g., in terms of symbol index, slot index, frame index, sub-frame index, absolute time, relative time with respect to a reference time (e.g., time when WTRU received the configuration, start time of the sensing window, etc.), etc.).

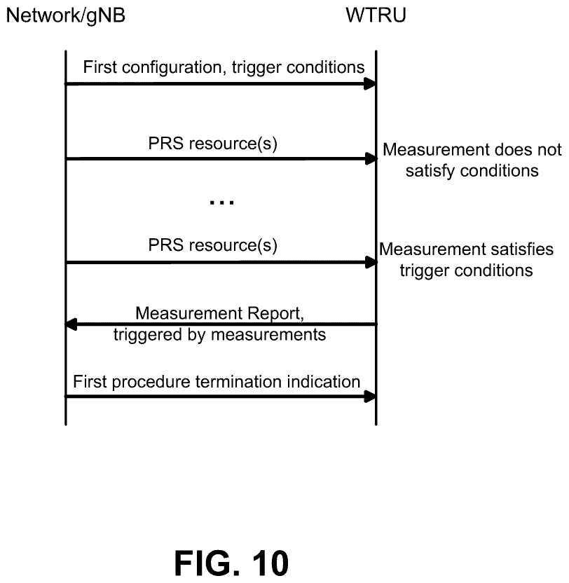

In certain representative embodiments, the WTRU may receive an indication to terminate the sensing procedure following the measurement report. In certain representative embodiments as illustrated in FIG. 10, the WTRU may receive first configuration and trigger conditions for the first procedure from the network. The WTRU may receive the configured resource(s) and based on measurement(s) may determine whether the trigger condition(s) are met. The WTRU may report the measurement(s) to the network if the measurement(s) satisfies the trigger conditions. The WTRU may receive an indication to terminate the first procedure.

### Second Measurement and Reporting Procedures

In certain representative embodiments, the WTRU may receive an indication from the network to activate the second procedure (e.g., including second configuration(s) and/or assistance information(s)). In one example, the request may be after the WTRU request to the network for activation.

In another example, the WTRU may determine to request for or activate a second procedure based on at least one of the following conditions:

a) The WTRU receives an indication from the network, where the indication may be at least one of the following: i) Indication (e.g., DCI, MAC-CE, etc.) to activate one or more configuration(s) associated with the second procedure ii) Configuration (e.g., DL-PRS, measurement, reporting, etc.) and/or assistance information associated with a second procedure, iii) Time window activation indication or configuration associated with second procedure.

b) The WTRU determines the measurement(s) (e.g., multipath measurements) satisfy at least one or a combination of condition(s) and/or trigger events (e.g., the events and conditions similar to as described for event-based reporting) and/or assistance information(s), etc.

c) The WTRU determines the target object is located in a reference location and/or an area (e.g., coarse location, zone ID, etc.) associated with at least one of the: i) termination of first procedure, ii) activation of (e.g., configuration(s) associated with) second procedure, etc.

d) The WTRU determines the WTRU is located in a reference location and/or reference area (e.g., coarse location, zone ID, etc.) associated with at least one of the: i) termination of first procedure, ii) activation of (e.g., configuration(s) associated with) second procedure, etc.

c) The WTRU determines the path measurements (e.g., RSRPP and/or Doppler shift) is above a (pre)configured threshold.

f) The WTRU determines that its error in positioning is below a (pre) configured threshold.

g) The WTRU determines the change of and/or the rate of change of path measurements (e.g., RSRPP and/or Doppler shift and/or AoA and/or relative delay) is above a (pre) configured threshold.

h) The WTRU velocity is below a (pre) configured threshold.

i) The object velocity is above a (pre) configured threshold, etc.

In certain representative embodiments, the WTRU may receive an acknowledgement message (e.g., yes, ACK) or negative acknowledgement message (e.g., no, NACK) to the request to start the second procedure.

In certain representative embodiments, the WTRU may be configured or may determine to deactivate or terminate the first procedure based on the after receiving the configuration or indication to initiate the second procedure.

In certain representative embodiments, the WTRU may receive a second configuration and second assistance information from the network. In certain representative embodiments, the WTRU may receive an indication from the network to activate or deactivate the (pre) configured (e.g., set of) second configuration(s) (PRS ID(s), DL-PRS configuration(s), measurement configuration(s), reporting configuration(s)) and/or second assistance information (e.g., DCI, MAC-CE, RRC, LPP, indication or any other messages or signals from the network). The WTRU may receive the indication in the form of at least one of the following:

a) Second configuration (e.g., DL-PRS configuration, measurement configuration, reporting configuration, etc.).

b) Activated and/or deactivated time window ID and/or time window parameters associated with the second procedure.

c) Activated and/or deactivated Configuration ID (e.g., DL-PRS ID, measurement configuration ID, reporting configuration ID).

d) Activated and/or deactivated second assistance information ID and/or second assistance information.

e) Activated and/or deactivated TCI state ID(s) and/or TCI-UL State ID(s), for example, activation of DL-PRS ID(s) and/or resource(s) associated with the TCI-state ID and/or TCI-UL state ID.

f) Activated and/or deactivated TRP ID(s).

g) Tracking path ID(s), where the tracking path ID(s), in certain representative embodiments, may be the path ID reported by the WTRU to the network (e.g., during the first procedure).

h) Reference measurements (e.g., associated with the tracking path ID), for e.g., RSRPP, Doppler spread AoA, relative excess delay, etc. (e.g., associated with the tracking path ID), etc.

i) Object location (e.g., 3D location, 2D location, location area (e.g., coarse location, zone ID, etc.) and/or associated uncertainty.

j) Object velocity (e.g., in meters/seconds) and/or associated uncertainty.

In certain representative embodiments, the WTRU may receive at least one of the above indication one or more times during the second procedure, such as:

a) Before one or more measurement occasions.

b) After one or more reporting occasions.

c) After receiving the activation or configuration for second procedure.

d) Before receiving termination indication for second procedure, etc.

The WTRU may use the indication as an update from the network (e.g., configuration activation/deactivation, network report of the object location/velocity, etc.).

### Description of Time Window for Second Procedure

In certain representative embodiments, the WTRU may be (pre) configured with the time window(s) for the second procedure. The window(s) for the second procedure may consist of at least one of the following parameters:

a) Time Window ID.

b) Start and/or end time (e.g., expressed in terms of relative time or symbol number, slot number, subframe number or frame number). The relative time may be with respect to a reference time where the reference time may be at least one of the following: i) The time instance when WTRU received the configuration(s) from the network, ii) The time instance of reporting of first procedure termination, iii) The time instance of indication from the network to initiate the second configuration, etc.

c) Duration (e.g., expressed in terms of number of symbols, slots, subframes, frames, milliseconds, seconds, etc.).

d) Offset (e.g., in terms of symbol offset, slot offset, subframe offset, frame offset, relative time offset (e.g., in milliseconds) with respect to a reference time) where the reference time may be the same as the ones mentioned for start and/or end time.

c) Periodicity (e.g., expressed in terms of number of symbols, slots, subframes, frames, milliseconds, seconds).

In certain representative embodiments, the WTRU may receive the activation of time window (e.g., with time window ID and one or more of the time window parameters).

### Description of Activation/Deactivation or Switching of Configuration(s) for Second Procedure

In certain representative embodiments, the WTRU may receive an indication (e.g., DCI, MAC-CE, RRC, LPP and/or any other messages and/or signals) from the network to activate, deactivate and/or switch the (pre) configured (e.g., set of) second configuration(s) (PRS ID(s), DL-PRS configuration(s), measurement configuration(s), reporting configuration(s)) and/or second assistance information.

In certain representative embodiment, the WTRU may receive the indication to either activate a set of resource(s) (e.g., configuration(s), beam(s), TRP(s), etc.) or deactivate the set of resource(s). The WTRU may receive the indication in the form of at least one of the following:

a) activated and/or deactivated Configuration (e.g., DL-PRS configuration, measurement configuration, reporting configuration) and/or Activated Configuration ID (e.g., DL-PRS ID, measurement configuration ID, reporting configuration ID).

b) activated and/or deactivated second assistance information ID and/or second assistance information.

c) activated and/or deactivated TCI state ID(s) and/or TCI-UL State ID(s), for e.g., activation of DL-PRS ID(s) and/or resource(s) associated with the TCI-state ID and/or TCI-UL state ID.

d) activated and/or deactivated PRS resource and/or beam ID(s).

c) activated and/or deactivated TRP ID(s), etc.

In certain representative embodiments, the WTRU may only receive the indication in at least one of the following time durations:

a) Within the activated time window for the second procedure.

b) Within a (pre) configured time duration with respect to a reference time instance, where the reference time instance may be at least one of the following: i) Time of reception of configuration(s) associated with the second procedure, ii) Time of reception of (e.g., activated) activation indication (e.g., configuration activation, assistance information activation, etc.) from the network iii) Start time of the time window, iv) Time instance where the WTRU receives an indication of start of second procedure from the network, v) SFN0 time, etc.

Before the end of a reference time instance, where the reference time instance may be at least one of the following: i) End time of the (e.g., activated) time window, ii) Time instance where the WTRU receives an indication of end of second procedure from the network, etc.

In certain representative embodiments, the WTRU may only receive the indication if it is configured for the second procedure and/or satisfies at least one or more of the condition(s) and/or trigger event(s) associated with the second procedure.

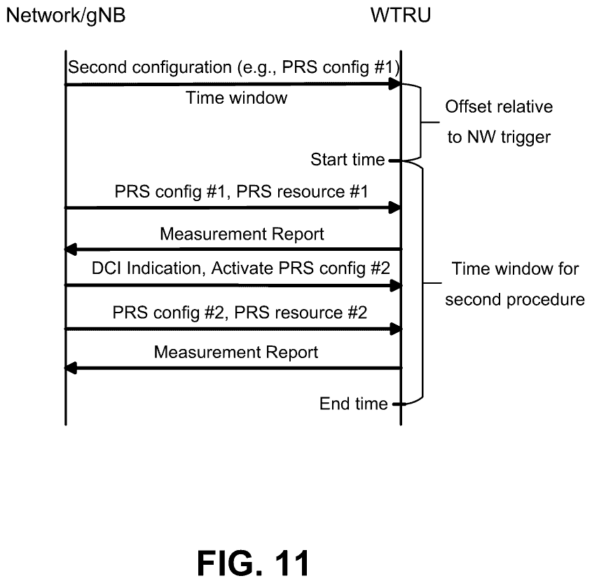

In certain representative embodiments, as illustrated in FIG. 11, the WTRU receives a DCI indication to activate a configuration (e.g., DL-PRS config #1). The WTRU then, following the measurement report, receives an activation of another configuration, i.e., DL-PRS config #2. The WTRU may receive this configuration only within the time window associated with the second procedure.

In certain representative embodiments, based on activation of one of the second configuration(s) (e.g., reporting configuration), the WTRU may activate the other second configuration(s) (e.g., assistance information, measurement configuration, etc.) associated with it.

In certain representative embodiments, the WTRU may receive the second configuration(s) and/or second assistance information from the network during one or more measurement occasions during the second procedure, e.g., from the network via downlink physical channel (e.g., PDSCH, PDCCH, etc.) or via lower or higher layer signalling (e.g., DCI, MAC-CE, RRC or LPP message).

In certain representative embodiments, the WTRU may receive one or more configurations parameter(s) and/or assistance information to add or modify to a second configuration (e.g., that may be activated or (pre) configured by the network) with the indication.

In certain representative embodiments, the WTRU may receive an index of the associated configuration where the WTRU may modify or add the configuration parameter. In certain representative embodiments, the WTRU may determine the modification of the parameter may modify or add the configuration parameter to the currently activated configuration.

In certain representative embodiments, the WTRU may receive both the activation of a subset of (pre) configured second configurations and/or second assistance information and one or more configuration parameter(s) to add or modify. The WTRU may activate the indicated configuration with modification or addition of the configuration parameter.

In certain representative embodiments, the WTRU may receive the validity duration associated with the second configuration (e.g., activated configuration) and/or second assistance information. In certain representative embodiments, the validity duration may be received by the WTRU in terms of absolute time instance, relative time duration, symbol no., slot no. subframe no. frame no., no. of symbols, no. of slots, no. of frames, no. of subframes, seconds, milliseconds, etc.).

In certain representative embodiments, the WTRU may receive a sequence of second configuration(s) and/or second assistance information(s) from the network associated with the resource(s) (e.g., time and/or frequency), indicating the sequence of configuration(s) to be activated or used in the one or more future occasion(s). In certain representative embodiments, the WTRU may receive a sequence of DL-PRS ID(s) to be used in next N occasion(s) from the network. In certain representative embodiments, the WTRU may receive a sequence of TRP ID(s) to make measurement(s) on in the next N occasion(s) from the network. The WTRU may receive a sequence of second configuration(s) and/or second assistance information may be associated with at least one of the following: i) Time offset (e.g., in terms of symbols, slots, frames, subframes, milliseconds, seconds, etc.) with respect to a reference time (e.g., time of reception of second configuration, time of reception of sequence indication, etc.) ii) Time instance (e.g., symbol index, slot index, subframe index, frame index, absolute time, etc.).

In certain representative embodiments, the WTRU may activate the configuration(s) (e.g., in sequence) in the indicated time instances.

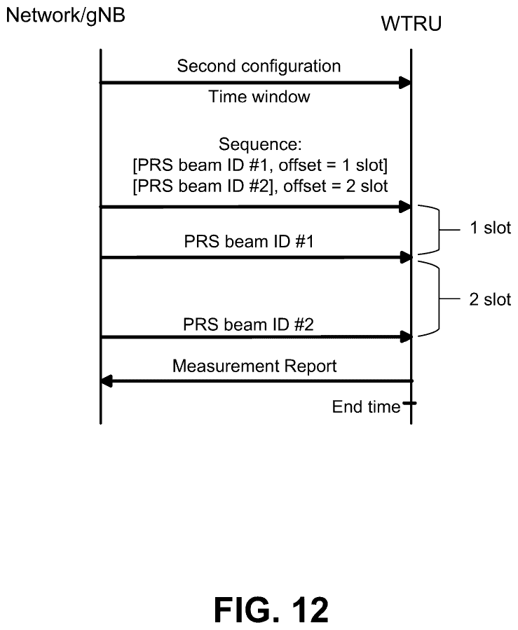

In certain representative embodiments, as illustrated in FIG. 12, the WTRU may receive the indication with a sequence of DL-PRS beam #1 and DL-PRS beam #2 from the network and the associated time indication (e.g., slot offset). The WTRU may determine to measure the DL-PRS beams on the determined slot offsets with respect the time when WTRU receives the sequence indication.

In certain representative embodiments, the activation indication or the configuration in one occasion may also be an indication to deactivate the previous configuration(s).

In certain representative embodiments, the activation of a configuration may deactivate the current configuration. For In certain representative embodiments, the activation of a configuration (e.g., second MeasConfig ID #2) may deactivate the current configuration (e.g., second MeasConfig ID #1). In certain representative embodiments, the activation may be deactivated if the configuration(s) are of the same type (e.g., new measurement configuration may deactivate the current measurement configuration only). In certain representative embodiments, the activation of a new configuration may deactivate the old configuration of the same type and other associated configuration(s) of a different type. For In certain representative embodiments, activation of a configuration (e.g. MeasConfig ID #2) may deactivate the current configuration of the same type (e.g., MeasConfig #1) and the associated configurations of a different type (e.g., ReportConfig ID #1).

In certain representative embodiments, the WTRU may only deactivate a configuration only based on the explicit indication from the network (e.g., via lower and higher layer signalling such as DCI, MAC-CE, RRC, LPP signals or downlink physical signals such as PDSCH, PDCCH, etc.).

In certain representative embodiments, the WTRU may determine to switch one or more of the second configuration(s) (e.g., DL-PRS ID(s) and or DL-PRS resource ID(s) for measurement, DL-PRS configuration, measurement configuration, reporting configuration, etc.) based on at least one or more combinations of the following conditions:

a) The measurement(s) associated with tracking path ID(s) is below a (pre) configured threshold, where the measurements may be at least one of: i) RSRPP measurements, ii) Doppler shift measurements.

b) The measured relative delay (e.g., with respect to a reference path, such as first path) associated with the tracking path ID is above a (pre) configured threshold.

c) The decrease (e.g., difference) in the measurement(s) associated with the tracking path ID(s) between measurement occasion(s) is above a (pre) configured threshold, where the measurement(s) may be at least RSRPP measurements and/or Doppler shift measurement.

In certain representative embodiments, the number of measurement occasion(s) for comparing the difference between measurement(s) may be configured by the network.

In certain representative embodiments, the WTRU may keep track of measurement(s) (e.g., average) between a configured N measurement occasion(s). The WTRU may compare the current measurement with the average.

d) The difference between the measurement(s) is above a (pre) configured threshold, where the measurements may be at least one of: relative excess delay and/or AoA associated with the tracking path.

c) The difference between object location (e.g., indicated by the network or determined by the WTRU) and a reference location is below a (pre) configured threshold.

f) The object velocity (e.g., indicated by the network or determined by the WTRU) is above a (pre) configured threshold.

g) The difference in the WTRU location and/or WTRU velocity between measurement occasion(s) is above a (pre) configured threshold.

h) The uncertainty in object location and/or velocity (e.g., indicated by the network and/or determined by the WTRU) is above a (pre) configured threshold.

i) The WTRU receives and indication from the network (e.g., via DCI or MAC-CE signalling), etc.

In certain representative embodiments, the WTRU may report if at least one of the above-mentioned trigger condition(s) to switch one or more of the second configuration(s) is satisfied. The WTRU may report at least one of the following: a) Event (e.g., switch DL-PRS, switch configuration, configuration ID, etc., etc.) b) Cause of report, e.g., Measurement difference WTRU location and/or associated uncertainty, WTRU velocity and/or associated uncertainty, Object location and/or associated uncertainty, Object velocity and/or associated uncertainty, etc. c) Measurements in the current and previous occasion(s) (e.g., associated with the tracking path ID).

### UE Determination of DL-PRS, Measurement and Reporting Configurations for Second Procedure

In certain representative embodiments, at least one or more of the procedures, conditions and/or events for determination of DL-PRS resource(s) and configuration associated with the first configuration or the first procedure may be valid for the second configuration or the second procedure.

The WTRU may also determine the DL-PRS resource(s) and/or DL-PRS ID(s) for measurement based on at least one of the following:

a) The WTRU may determine the DL-PRS resource(s) and/or DL-PRS beam(s) to measure and may measure the (e.g., additionally) other DL-PRS beam ID(s) (e.g., DL-PRS beams adjacent to the currently measured) if the measurement(s) (e.g., RSRPP and/or Doppler shift measurements) associated with the tracking path ID is below a threshold. In certain representative embodiments, the WTRU may measure the beam(s) spatially adjacent to the DL-PRS beam(s) measured in the current occasion.

b) The WTRU may determine the DL-PRS resource(s) and/or DL-PRS beam(s) to measure and may (e.g., additionally) measure the other DL-PRS beam ID(s) (e.g., DL-PRS beams adjacent to the currently measured) if the difference in measurement(s) (e.g., RSRPP and/or Doppler shift measurements and/or AoA measurements and/or relative delay measurements) between multiple measurement occasion(s) associated with the tracking path ID is above a threshold.

c) The WTRU may determine the DL-PRS resource(s) and/or DL-PRS ID(s) based on object location (e.g., indicated by the network or determined by the WTRU). In certain representative embodiments, the WTRU may receive the DL-PRS configuration with association to reference area(s) (e.g., coarse locations, zone IDs, etc.). The WTRU may determine to activate or measure the DL-PRS resource(s) and/or DL-PRS ID(s) associated with geographical area of the object location. In certain representative embodiments, the WTRU may determine to measure a DL-PRS ID #1 as it is associated with zone ID #1 where the object location is determined or indicated by the network to be in.

d) The WTRU may determine the DL-PRS resource(s) and/or DL-PRS ID(s) based on the WTRU location (e.g., determined by WTRU, indicated by the network). For example, the WTRU may receive association of DL-PRS ID(s) and/or DL-PRS resource ID(s) with WTRU location(s) and may determine to activate and measure the DL-PRS ID(s) and/or resource(s) based on this association. An example of association may be association of DL-PRS ID(s) with zone ID(s), coarse location(s), cell ID(s) etc. In certain representative embodiments, the WTRU may activate the DL-PRS ID(s) associated with a TRP if it determines that it is located in a cell ID associated with the TRP and/or the DL-PRS ID(s).

The WTRU may determine the DL-PRS resource(s) set (e.g., beamwidth of DL-PRS beam) based on i) the difference between the measurement(s) in multiple measurement occasion(s), ii) the measurement(s) (e.g., Doppler shift), iii) the velocity of the WTRU and/or object.

The WTRU may determine the TRP(s) and/or the number of TRP(s) for DL-PRS measurement based on the distance between the TRP and the object.

In certain representative embodiments, the DL-PRS configuration(s) may be associated with one or more TRP(s). The determination condition(s) and procedure(s) for DL-PRS configuration(s) and/or DL-PRS beam ID(s) determination may be the same for TRP ID or TRP determination.

In certain representative embodiments, at least one or more of the procedures, conditions and/or events for determination of measurement configuration(s) associated with the first configuration or the first procedure may be valid for the second configuration or the second procedure.

In certain representative embodiments, the WTRU may also determine the measurement configuration(s) based on at least one of the following:

a) The WTRU may determine the DL-PRS pattern and/or density for measurement (e.g., no. of symbols, comb size, comb pattern, no. of etc.) and/or frequency resource(s) (e.g., bandwidth, no. of PFLs, no. of PRBs, etc. based on at least one of the following: i) The uncertainty associated with the object location and/or object velocity, ii) The uncertainty associated with the WTRU location.

b) The WTRU may determine the DL-PRS repetition pattern (e.g., type of DL-PRS (e.g., periodic, aperiodic, semi-persistent, etc.) and/or muting pattern, etc. based on at least one of the following: i) The difference in measurement(s) (e.g., RSRPP, AoA, relative delay, etc.) between measurement occasions(s), ii) The measured RSRPP and/or Doppler shift, iii) The object velocity, iv) The WTRU velocity.

c) The WTRU may determine the L3 filtering coefficient and/or the number of measurement(s) per beam based on at least one of the following: i) The difference in the measurement(s) (e.g., RSRPP, AoA, relative delay, etc.) between measurement occasions, ii) The uncertainty associated with the object location and/or object velocity and/or WTRU location, etc.

The WTRU may determine TRPs and/or PRSs to make measurements. In certain representative embodiments, the WTRU may be configured with a set of TRPs, cell IDs and/or PRSs to make measurements from where each set may be associated with an ID. The WTRU may receive an activation command from the network with an ID, activating measurements on the corresponding set of TRPs, cells and/or PRS. In certain representative embodiments, the WTRU may be configured with an order to make measurements. The WTRU may be configured which PRSs and/or TRPs to measure first. In certain representative embodiments, the WTRU may be configured to make measurements on the PRSs received from TRP1, TRP2 and TRP3. The WTRU may be configured to make measurements in the order of TRP1, TRP2 and TRP3. The order of measurements may be associated with geographic references. In certain representative embodiments, the WTRU may receive an indication on which order of zones or areas to make measurements. The WTRU may determine which TRPs or PRSs to measure based on the zone.

In certain representative embodiments, at least one or more of the procedures, conditions and/or events for determination of reporting configuration(s) associated with the first configuration or the first procedure may be valid for the second configuration or the second procedure.

In certain representative embodiments, the WTRU may determine the reporting configuration based on at least one of the following:

a) The WTRU may determine the reporting type as event triggered configuration based on at least one of the following conditions: i) The object velocity and/or WTRU velocity is below a (pre) configured threshold, ii) The measured RSRPP and/or Doppler shift measurement is below a (pre) configured threshold, iii) The object is located in a geographical area such as a coarse location and/or a zone ID associated with an event triggered reporting configuration, iv) The periodicity associated with determined or configured measurement configuration is above a (pre) configured threshold, etc.

The WTRU may determine the reporting type as periodic otherwise.

The WTRU may determine at least one of the reporting intervals, periodicity (e.g., for periodic measurement report), etc. based on at least one of the following:
a) The object velocity and/or WTRU velocity.
b) WTRU velocity.
c) The distance between the WTRU and the object.
d) Measurements (e.g., the measured relative delay (e.g., with respect to the first path), the measured AoA, etc. of the tracking path ID).

In certain representative embodiments, the WTRU may determine the DL-PRS and/or measurement and/or reporting configuration based on at least one of the following conditions:

a) object location (e.g., object located in a geographical area such as zone ID and/or coarse location, e.g., associated with a DL-PRS and/or measurement and/or reporting configuration).

b) WTRU location (e.g., WTRU located in a geographical area such as zone ID and/or coarse location, e.g., associated with a DL-PRS and/or measurement and/or reporting configuration).

c) the distance between the object and the WTRU.

d) the distance between the object and the TRP.

e) the object and/or WTRU velocity.

f) the measurement(s) (e.g., RSRPP and/or Doppler shift and/or AoA and/or relative delay measurements associated with the tracking path), etc.

In certain representative embodiments, each DL-PRS and/or measurement and/or reporting configuration(s) and/or assistance information may be associated with each other and activation of one configuration (e.g., by the network or the WTRU) may activate the associated configurations.

In certain representative embodiments, the WTRU may report at least one of the preferred determined DL-PRS resource ID(s) and/or DL-PRS ID(s) and/or DL-PRS resource set(s) and/or TRP ID(s) and/or measurement configurations(s) (e.g., ID) and/or reporting configuration(s) (e.g., ID), to the network. The WTRU may report at least one of the following: i) Determined/preferred DL-PRS resource ID(s) and/or DL-PRS ID(s) and/or DL-PRS resource set(s) and/or TRP ID(s) ii) Determined/preferred measurement configuration(s) (e.g., ID(s)) iii) Determined/preferred reporting configuration(s) (e.g., ID(s)) iv) Determined/preferred TRP ID(s) and/or cell ID(s).

The WTRU may receive an acknowledgement message (e.g., Yes, ACK, etc.) or a negative acknowledgement message (NACK, No) from the network, granting or rejecting the preferred configuration activation request. In certain representative embodiments, the WTRU may receive a set of DL-PRS resource ID(s) and/or DL-PRS ID(s) and/or DL-PRS resource set(s) and/or TRP ID(s) and/or measurement configurations(s) (e.g., ID) and/or reporting configuration(s) (e.g., ID) from the network for measurement (e.g., same or different as compared to the WTRU determination and/or report).

In certain representative embodiments, the WTRU may perform measurements based on the second configuration in one or more than one measurement occasion(s).

The WTRU may perform the measurements for the second procedure similarly to at least one of the procedures defined for the first procedure. Additionally, the WTRU may also perform at least one of the following procedures for the measurements.

In certain representative embodiments, the WTRU may be configured to perform the path measurement(s) on the (pre) configured reference DL-PRS ID(s). In certain representative embodiments, the reference DL-PRS ID(s) may the same or different compared to previous measurement occasion(s) (e.g., determined by the WTRU or indicated by the network).

In certain representative embodiments, the WTRU may be configured or may determine the direction of the receive beam for measurement and/or allocation of path ID(s) at least similarly to the procedure defined for the first measurement procedure with the first assistance information. Additionally, the WTRU may also determine the beam direction based one of the following:

a) AoA indication (e.g., between minimum AoA and maximum AoA or expected AoA with respect to the indicated reference). In certain representative embodiments, the WTRU may be configured with a relative AoA range (e.g., in terms of degrees or radians) with respect to a reference (e.g., measured AoA in the previous measurement occasion(s)). The WTRU may determine the Rx beams based on the AoA indication (e.g., associated with the second assistance information).

b) relative delay indication and/or RSRPP threshold. In certain representative embodiments, the WTRU may be configured with a relative delay indication in the second assistance information where the reference for the relative delay is relative delay measurement with reference to the previous measurement occasion. The WTRU may determine the beam based on this relative delay indication. In certain representative embodiments, the RSRPP threshold may be relative to the RSRPP measurement or RSRPP threshold configured in the previous measurement occasion. The WTRU may determine the beam direction based on the difference in RSRPP value.

c) difference between the (e.g., indicated) reference location/object location compared to the previous measurement occasion(s). In certain representative embodiments, for measurement in the second procedure, the WTRU may be configured with the measurements or report (e.g., path profile) from previous measurement and/or reporting occasion(s) as the reference.

In certain representative embodiments, the WTRU may be configured by the network with event-based reporting for the second procedure.

In certain representative embodiments, the WTRU may be configured by the network or may determine to perform either event triggered reporting or a periodic reporting. The reporting procedure for the second procedure and second configuration may be same as the first procedure.

In certain representative embodiments, the WTRU may be configured by the network to determine an association between the measurement(s) associated with the tracking path with respect to a reference path profile or measurement(s). In certain representative embodiments, the reference path profile may be the measurement(s) in the previous measurement and/or reporting occasions.

In certain representative embodiments, the WTRU may determine an association between the tracking path ID and a measured path based on at least one of the following:

a) The measured path is within the AoA range (e.g., from the second assistance information).

b) The measured path is with the relative delay range (e.g., from the second assistance information).

c) The RSRPP and/or Doppler shift measurement associated with the path is above a (pre) configured threshold.

d) The difference between measurement(s) (e.g., RSRPP, Doppler shift, AoA, relative delay) between the path and the tracking path ID is below a (pre) configured threshold.

c) The duration between a reference time and the time of path measurement is below a (pre) configured threshold, where the reference time may be at least one of the: i) time instance when the WTRU receives the indication (e.g., DCI) with the second configuration indication, ii) previous measurement occasion, etc.

In certain representative embodiments, the WTRU may report in the event triggered reporting only if the conditions related to path association(s) are satisfied.

In certain representative embodiments, the WTRU may report event of no association if time elapsed since a reference time is above a (pre) configured threshold. In one example, the reference time may be at least one of the following:

a) time instance of previous reporting.

b) time instance since the UE starting path measurement, etc.

In certain representative embodiments, for the periodic reporting, if at least one association conditions is not satisfied, the WTRU may report the event of no association.

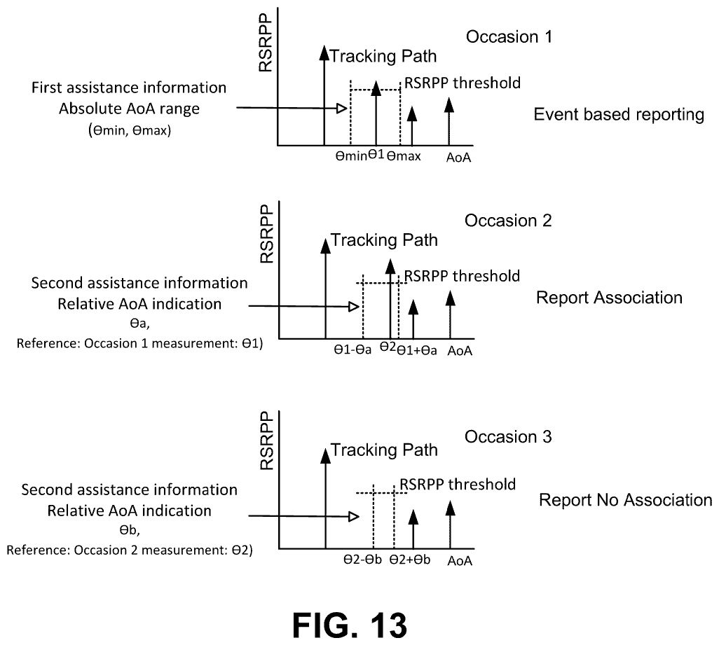

FIG. 13 illustrates an example for indicating an association and no association events according to one or more embodiment. In certain representative embodiments, as illustrated in FIG. 13, the WTRU may determine an association for the first procedure based on absolute AoA range (e.g., θmin and θmax). The WTRU may determine a path with measurement(s) above a (pre) configured threshold within the AoA range. In second occasion, for e.g., for a second procedure, the WTRU may be configured with a relative range (e.g., AoA range 2θa with respect to a reference which is the measurement in previous occasion, i.e., θ1). The WTRU may determine association in the second measurement occasion based on the AoA measurement within the indicated range with RSRPP measurement of the path above a (pre) configured threshold. In occasion 3, the WTRU may determine no association based no path detection within the indicated AoA range. In certain representative embodiments, in the measurement occasions for second procedure (e.g., Occasion 2 and Occasion 3), the WTRU may receive an activation of an assistance information (e.g., relative AoA range with different ranges (e.g., 2θa for occasion 2 and 2θb for occasion 3) for measurement (e.g., association). In certain representative embodiments, the WTRU also may receive an indication to use the reference measurement(s) from previous occasion(s) as the reference for measurement(s) in the current occasion.

In certain representative embodiments, the WTRU may report L1 measurement results without the L3 filtering for the second procedure. The procedure for L3 measurement may require filtering the measurement(s) over more than one sample(s) and/or occasions. However, for the second procedure, the WTRU may be configured to report with just L1 filtering. In certain representative embodiments, the WTRU may perform L1 measurement reporting if the no. of measurement occasion(s) or measurement reports or no. of sample(s) per reporting occasion is below a (pre)configured threshold.

In certain representative embodiments, the WTRU may report at least one of the following in every reporting occasion:

a) Event of association and/or no association.

b) Activated configuration ID (e.g., DL-PRS configuration ID(s), measurement configuration ID(s), reporting configuration ID(s)).

c) Activated assistance information ID.

d) TRP ID(s)/Cell ID(s) associated with the path measurement(s).

c) Measurement RS type (e.g., SSB, CSI-RS, DL-PRS).

f) Measurement(s) associated with tracking path ID(s) (e.g., of N occasion(s) where N may be configured by the network, occasion(s) since previous reporting occasion, etc.).

g) Measurement(s) associated paths other than tracking path ID(s) (e.g., of N occasion(s) where N may be configured by the network, occasion(s) since previous reporting occasion, etc.). h) Uncertainties associated with the measurement(s).

i) WTRU location information including at least one of the: WTRU location coordinates, Location time stamp (e.g., in terms of symbol index, slot index, subframe index, frame index, absolute time, relative time with respect to a reference), WTRU velocity estimate, WTRU location error, WTRU location source (e.g., RAT based, GNSS based, etc.).

j) WTRU geographical area information, E.g., WTRU coarse location, WTRU location zone ID, etc.

k) Report trigger event (e.g., Event ID).

### Terminating Second Procedure

In certain representative embodiments, the WTRU may determine to terminate or deactivate the second procedure based on at least one or a combination of the following conditions:

a) The WTRU may receive an indication (e.g., DCI indication) from the network.

b) The WTRU may determines the event of no association.

c) The (e.g., consecutive) number of occasions of no association is above a (pre) configured threshold.

d) The time duration since a reference time is above a (pre) configured threshold, where the reference time may be at least one of the following: The activation time instance of second procedure, The start time of the second procedure time window, The time instance when the WTRU received the configuration for sensing.

c) The WTRU may determine that the error in its positioning information is above a (pre) configured threshold.

f) The expiry of the second procedure time window.

In certain representative embodiments, the WTRU may be configured by the network to report the measurement(s) after termination (e.g., report on leave configuration) of the second procedure, e.g., for both event triggered and/or periodic reporting.

In certain representative embodiments, the WTRU may determine to activate the first procedure after terminating the second procedure based on at least one the following:

a) The WTRU may receive indication (e.g., configuration) from the network to activate the first configuration or procedure.

b) The WTRU location is in one of the (pre) configured geographical areas (e.g., coarse area, zone ID) associated with the first configuration.

c) The velocity of the WTRU is below a (pre) configured threshold, etc.

In certain representative embodiments, the WTRU may receive a first configuration and/or the first assistance information from the network for the first procedure.

In certain representative embodiments, the WTRU may receive an activation or indication of a first configuration ID (e.g., DL-PRS configuration ID, DL-PRS resource ID(s), DL-PRS ID(s), measurement configuration ID(s), reporting configuration ID(s)) and/or the assistance information to perform sensing for the first procedure. E.g., the configuration and the assistance information may be (e.g., a subset of) what the WTRU used previously.

In certain representative embodiments, the WTRU may determine to transition into the first procedure based on the measurement(s) in the second procedure. For e.g., the WTRU may determine the assistance information for the first configuration based on measurements in the second procedure, for e.g.,

a) The WTRU may determine the AoA range based on, angle range with number of paths above a (pre) configured threshold, AoA with measurement(s) (e.g., RSRPP, Doppler shift) above a (pre) configured threshold, AoA range associated with the last measurement occasion before termination of second procedure, etc.

b) The WTRU may determine the relative delay range based on, Relative delay range with number of paths above a (pre) configured threshold, Relative delay with measurement(s) (e.g., RSRPP, Doppler shift) above a (pre) configured threshold, Relative delay range associated with the last measurement occasion before termination of second procedure, etc.

c) The WTRU may determine the reference location as the location, and/or geographical area of the object in the last measurement occasion before termination of second procedure.

d) The WTRU may determine the reference DL-PRS ID for the first procedure as the DL-PRS ID(s) measured in the last measurement occasion before termination of second procedure, etc.

In certain representative embodiments, the WTRU may determine to terminate the sensing procedure based on at least one of the following:

a) the WTRU may receive an indication from the network.

b) the WTRU may determine the expiry of the sensing time window.

c) the WTRU may determine the higher priority of other signals (e.g., communication signals).

d) the velocity of the WTRU is above a (pre) configured threshold.

e) the velocity of the object is below a (pre) configured threshold.

f) the error in WTRU position is above a (pre) configured threshold.

g) the measurement or change in measurement (e.g., between measurement occasions) is below a (pre) configured threshold.

h) the uncertainty of sensing measurement (e.g., path measurement) is above a (pre) configured threshold.

i) the WTRU is located in the geographical area (e.g., coarse location, zone ID, etc.) associated with no sensing procedure.

j) the object is located in the geographical area (e.g., coarse location, zone ID, etc.) associated with no sensing procedure, etc.

In certain representative embodiments, the WTRU may receive configurations for periodic DL-PRS, first measurement and reporting (e.g., event-based) configurations and set(s) of second measurement (e.g., MeasConfig ID(s)) and reporting (e.g., periodic) reporting configurations (e.g., ReportConfig ID(s)) from the network.

The WTRU may receive first and second assistance information (e.g., Assistance ID(s)) including Ref. DL-PRS ID, and first and second set(s) of trigger conditions including [min, max] AoA range and RSRPP threshold.

The WTRU may receive DL-PRS resources, performs per path measurements (e.g., AoA, RSRPP) on the Ref. DL-PRS ID and allocates ID(s) to the path(s).

The WTRU may determine its Rx boresight direction and width based on the first trigger condition (e.g., [min, max] AoA range) for reporting.

The WTRU may measure the DL-PRS resources based on the first measurement configuration.

The WTRU may report the path ID(s) and the associated measurement(s) to the network based on the first trigger condition, i.e., if the measured AoA of a path ID with RSRPP above threshold is within the [min, max] AoA range.

The WTRU may receive an activation command for second configuration(s) with a tracking window (e.g., start time, duration) with tracking path ID from the network.

The activation command may activate the second set(s) of measurement and reporting (e.g., periodic) configuration(s) and second set(s) of trigger conditions.

For tracking the object, in every measurement occasion, the WTRU may at least one of:
a) receive (e.g., via DCI) indication of a second trigger(s) (e.g., Assistance ID) from the network,
b) determine the DL-PRS resource for measurement based on: DL-PRS ID associated with the tracking path ID (e.g., in previous occasion), (E.g., difference of) RSRPP and AoA measurement in previous occasion(s), (E.g., DCI) indication from the network, etc.,
c) determine parameter(s) of second measurement (e.g., periodicity, k-factor, etc.) and/or second reporting (e.g., periodicity, granularity, etc.) configuration based on: (E.g., difference of) RSRPP and AoA measurement in previous occasion(s), WTRU location (e.g., located in a zone), (e.g., DCI) indication from the network (e.g., MeasConfig ID and/or ReportConfig ID) etc.,
d) receive and measures the path(s) with tracking DL-PRS ID(s) based on the determined measurement configuration,
e) associate the measurement of a path to that of the tracking path ID based on the indicated trigger, i.e. measured AoA of a path with RSRPP above threshold within the [min, max] AoA range), and
f) report the updated measurements if associated with the tracking path ID and an event of no association otherwise.

The WTRU may determine to deactivate the tracking window and terminate the second procedure if: the number of (e.g., consecutive) no association events is above a threshold, the tracking window expires, or the WTUR receives window deactivation command from the network.

The WTRU may revert to performing measurements and reporting based on the first measurement and reporting condition based on the first assistance information.

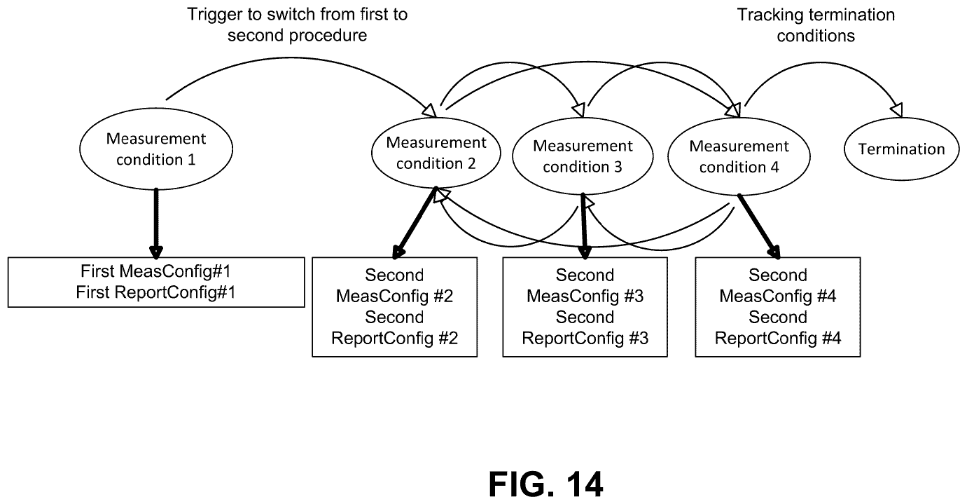

FIG. 14 illustrates an exemplary change in measurement and/or reporting configuration based on measurement conditions according to one or more embodiment. In certain representative embodiments, as illustrated in FIG. 14, the WTRU may be configured with the events (e.g., measurement condition(s) in the figure) where each condition may be associated with measurement and/or reporting configuration(s). Based on the first MeasConfig #1, the WTRU may determine the measurement satisfies measurement condition 1 and reports to the network with first ReportConfig #1. The WTRU may switch from first to second procedure based on the event.

In certain representative embodiments, the WTRU may switch measurement and/or reporting configuration(s) based on the measurement satisfying the events (e.g., measurement conditions). If the WTRU may determine the measurements satisfy the termination condition, the WTRU may terminate the sensing procedure.

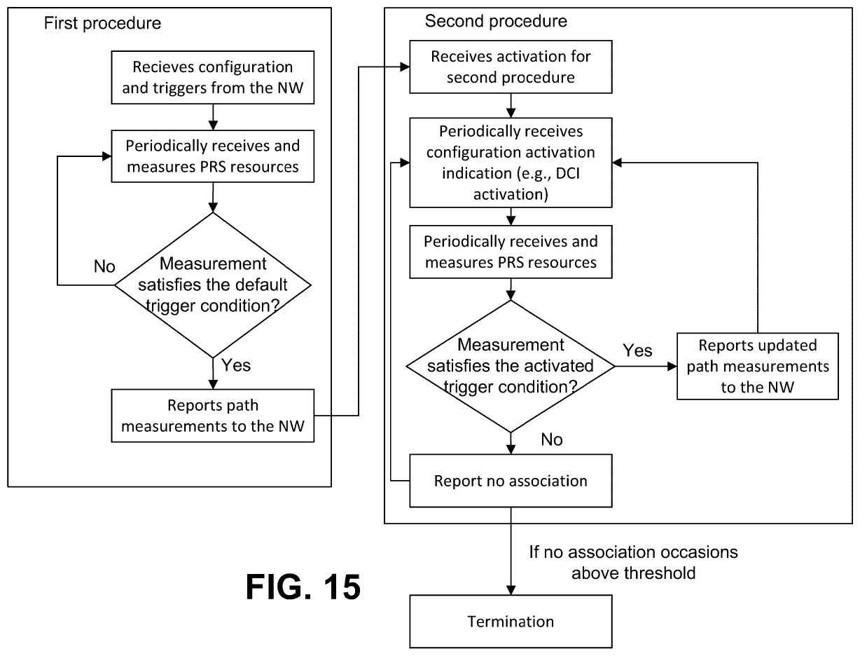

FIG. 15 illustrates a flowchart of an example of a procedure according to one or more embodiment. The flowchart of FIG. 15 may be an exemplary solution for the first procedure and the second procedure. For the first procedure the WTRU may be configured with event-based reporting and may report if the measurements satisfy the indicated trigger conditions.

In the second procedure, the WTRU may be configured with a periodic reporting configuration and may report the measurements periodically. In the second procedure, the WTRU may also receive an indication from the network (e.g., DCI activation) activating configuration(s) for measurement and/or reporting.

The WTRU may terminate the procedure if the WTRU determines an event of no association of the measurements between measurement occasions.

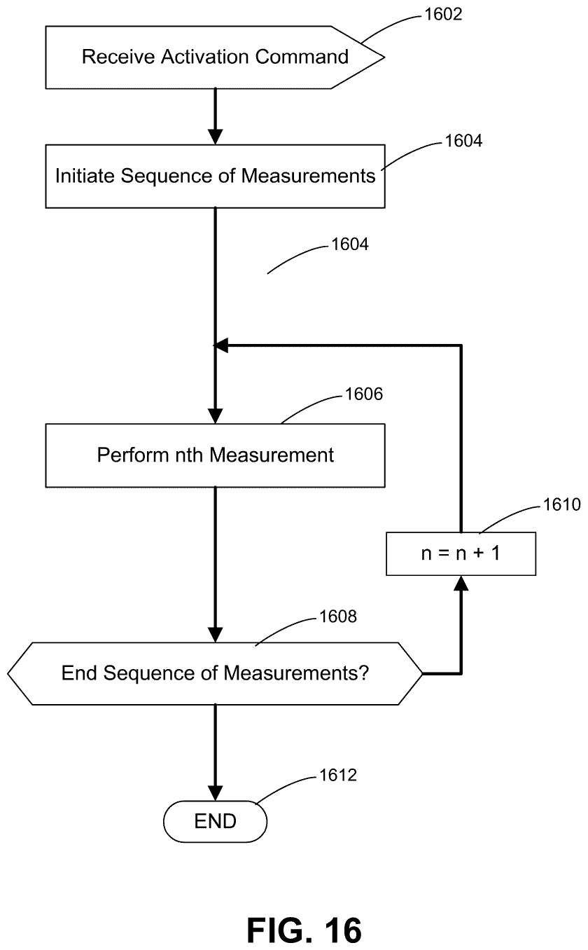

FIG. 16 illustrates the activation of a dynamically configurable sensing method which may be performed by a WTRU. The WTRU may receive 1602 an activation command, and may perform a dynamically configurable sensing method (1604 to 1612) in response to receiving the activation command. To perform the dynamically configurable sensing method, the WTRU may initiate 1604 a sequence of measurements. To perform the sequence of measurements the WTRU may initialize 1604 a counter, and may repeat a measurement cycle (1606, 1608, 1610) a plurality of times. In each iteration of a measurement cycle, the WTRU may perform a dynamically configured sensing measurement 1606, test 1608 a condition to determine whether the sequence of measurements should end, and increment 1610 the counter if the test determines that the sequence of measurements should continue. In the event that the test determines that the sequence should end, the WTRU may end the dynamically configurable sensing method.

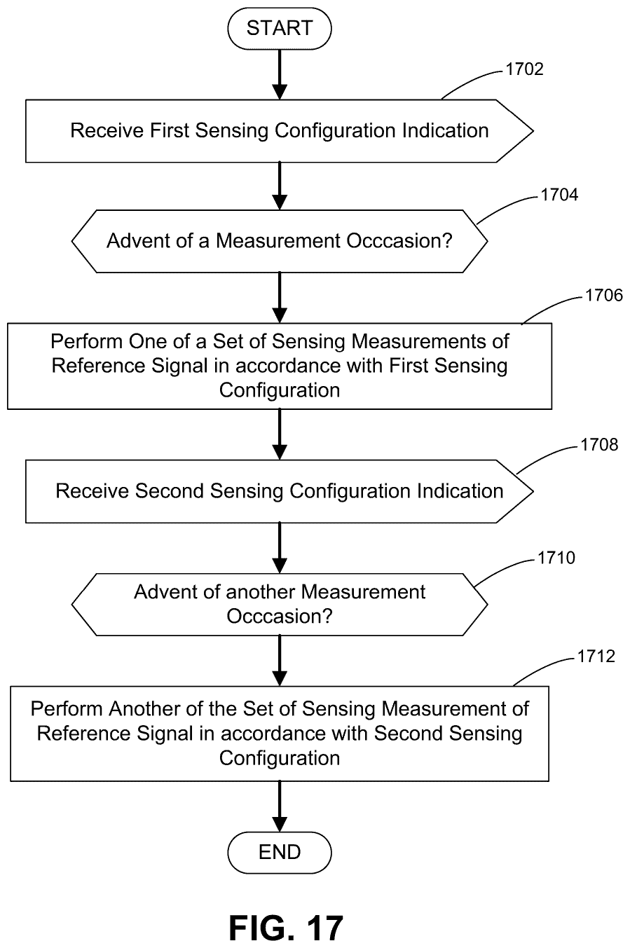

FIG. 17 illustrates a dynamically configurable sensing measurement method which may be performed by a WTRU. In certain representative embodiments, the set of dynamically configurable sensing measurements may be performed after the WTRU receives a tracking activation command in association with tracking path information indicative of a reference signal path to be measured, and a tracking path identifier. The WTRU may perform a set of sensing measurements of a reference signal on respective predetermined occasions. The WTRU may receive 1702 a first sensing configuration indication (e.g. an identifier of a sensing configuration stored on the WTRU, or a first sensing configuration). The WTRU may detect 1704 the advent of a measurement occasion on which one of the set of sensing measurements is to be performed, and perform 1706 the one of the set of sensing measurements in accordance with the first sensing configuration. The WTRU may receive 1708 (e.g. an identifier of a sensing configuration stored on the WTRU, or a first sensing configuration) a first sensing configuration indication (e.g. an identifier of another sensing configuration stored on the WTRU, or another sensing configuration). The WTRU may detect 1710 the advent of another measurement occasion on which another of the set of sensing measurements is to be performed, and perform 1712 the other of the set of sensing measurements in accordance with the second sensing configuration.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-ID. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method performed by a wireless transmit/receive unit (WTRU), the method comprising:
receiving a tracking activation command in association with tracking path information indicative of a reference signal path to be measured, and a tracking path identifier;
performing a set of sensing measurements of the reference signal path on respective predetermined measurement occasions by:
receiving a first sensing configuration indication;
on one of the predetermined measurement occasions, performing at least one sensing measurement of the set of sensing measurements of the reference signal path in accordance with the first sensing configuration;
transmitting a report of the at least one sensing measurement in association with the tracking path identifier;
receiving a second sensing configuration indication different from the first sensing configuration;
on a later one of the predetermined measurement occasions, performing at least one other sensing measurement of the set of sensing measurements of the reference signal path in accordance with the second sensing configuration; and
transmitting a report of the at least one other sensing measurement in association with the tracking path identifier.

2. The method of claim 1 wherein the WTRU receives a sequence of configuration indications indicating the sequence of configurations to be used on future measurement occasions.

3. The method of claim 1, wherein the first and second configuration indications are in Downlink Control Information (DCI) received by the WTRU.

4. The method of claim 1, wherein each of the first and second sensing configurations comprises one or more of reference signal information, measurement configuration and reporting configuration.

5. The method of claim 1 further comprising:
receiving assistance information for sensing a target object;
determining, for each sensing measurement of the set of sensing measurements, based on the assistance information, an association condition between the sensing measurement and the tracking path identifier; and
in response to the association condition being met, associating the sensing measurement with the tracking path identifier.

6. The method of claim 5, wherein the assistance information comprises a range of angle of arrival of the reference signal path, and a threshold reference signal received path power, the association condition being met if the reference signal received path power on a path corresponding to the range of arrival of the reference signal exceeds a threshold.

7. The method of claim 5 further comprising, in response to the association condition being met, reporting the sensing measurement of the reference signal path to a wireless network.

8. The method of claim 5 further comprising, in response to the association condition not being met, determining a no association event, and terminating the performing of the set of sensing measurements in response to the number of no association events exceeding a threshold.

9. The method of claim 5 wherein the assistance information comprises one or more reference locations of a sensing object, at least some of the sensing measurements of the set of sensing measurements of the reference signal path being based on the reference locations.

10. The method of claim 1 wherein the activation command further comprises tracking window information, the method further comprising terminating the performing of the set of sensing measurements in response to the expiry of the tracking window.

11. A wireless transmit/receive unit (WTRU) comprising:
a processor, and
a transceiver coupled to the processor, wherein the WTRU is configured to:
receive a tracking activation command in association with tracking path information indicative of a reference signal path to be measured, and a tracking path identifier;
perform a set of sensing measurements of the reference signal path on respective predetermined measurement occasions by:
receiving a first sensing configuration indication;
on one of the predetermined measurement occasions, performing at least one sensing measurement of the set of sensing measurements of the reference signal path in accordance with the first sensing configuration;
transmitting a report of the at least one sensing measurement in association with the tracking path identifier;
receiving a second sensing configuration indication different from the first sensing configuration;
on a later one of the predetermined measurement occasions, performing at least one other sensing measurement of the set of sensing measurements of the reference signal path in accordance with the second sensing configuration; and
transmitting a report of the at least one other sensing measurement in association with the tracking path identifier.

12. The WTRU of claim 11 wherein the WTRU is further configured to receive a sequence of configuration indications indicating the sequence of configurations to be used on future measurement occasions.

13. The WTRU of claim 11, wherein the first and second configuration indications are in Downlink Control Information (DCI) received by the WTRU.

14. The WTRU of claim 11, wherein each of the first and second sensing configurations comprises one or more of reference signal information, measurement configuration and reporting configuration.

15. The WTRU of claim 11, the WTRU being further configured to:
receive assistance information for sensing a target object;
determine, for each sensing measurement of the set of sensing measurements, based on the assistance information, an association condition between the measurement and the tracking path identifier; and
in response to the association condition being met, associate the sensing measurement with the tracking path identifier.

16. The WTRU of claim 15, wherein the assistance information comprises a range of angle of arrival of the reference signal path, and a threshold reference signal received path power, the association condition being met if the reference signal received path power on a path corresponding to the range of arrival of the reference signal exceeds a threshold.

17. The WTRU of claim 15 wherein the WTRU is further configured to, in response to the association condition being met, report the measurement of the reference signal path to a wireless network.

18. The WTRU of claim 15 wherein the WTRU is further configured to, in response to the association condition not being met, determine a no association event, and terminate the performing of the set of sensing measurements in response to the number of no association events exceeding a threshold.

19. The WTRU of claim 15 wherein the assistance information comprises one or more reference locations of a sensing object, each of the set of measurements of the reference signal being based on the reference locations.

20. The WTRU of claim 11 wherein the activation command further comprises tracking window information, the WTRU being further configured to terminate the performing of the set of sensing measurements in response to the expiry of the tracking window.
